(19) United States
(12) Patent Application Publication
(10) Pub. No.: US 2026/0269692 A1
(43) Pub. Date: Sep. 10, 2026

(54) CONTROL DEVICE FOR BEARINGLESS MOTOR, MOTOR SYSTEM, AND CONTROL METHOD FOR BEARINGLESS MOTOR

(71) Applicant: Mitsubishi Electric Corporation, Tokyo (JP)

(72) Inventors: Masahito MIYOSHI, Tokyo (JP); Yusuke SAKAMOTO, Tokyo (JP); Shinichi FURUTANI, Tokyo (JP)

(73) Assignee: Mitsubishi Electric Corporation, Tokyo (JP)

(21) Appl. No.: 18/871,910

(22) PCT Filed: Jul. 14, 2022
(86) PCT No.: PCT/JP2022/027712

§ 371 Date: Dec. 5, 2024

(51) Int. Cl. H02K 11/27; H02P 23/14

(52) U.S. Cl. CPC H02K 11/27; H02P 23/14

(57) ABSTRACT

Provided is a control device for a bearingless motor including a rotor and a stator including an electric motor winding, the control device including an observer and a speed estimator. The observer computes an estimated current and/or an estimated rotor magnetic flux based on a voltage command value of the electric motor winding or a voltage detection value applied to the electric motor winding, the estimated current flowing through the bearingless motor, the estimated rotor magnetic flux generated in the electric motor winding by the rotor. The speed estimator calculates an estimated axial speed of the rotor in response to input of a current error and/or the estimated rotor magnetic flux, the current error being a difference between the estimated current and a current detection value of the electric motor winding.

### FIELD

The present disclosure relates to: a control device for a bearingless motor (or a bearing-less motor) including a rotor which is supported in a non-contact manner with respect to the stator by being magnetically levitated and which rotates; a motor system; and a control method for a bearingless motor.

### BACKGROUND

Bearingless motors have the function of an electric motor that generates torque and the function of a magnetic bearing that generates a supporting force for levitating the rotor in a non-contact manner with respect to the stator, both functions being on the same magnetic circuit. In order to levitate the rotor, it is necessary to actively control all the five degrees of freedom excluding the rotation axis, or to form a passively stable structure without actively controlling the five degrees of freedom partially.

In a bearingless motor of the two-axis control type, a sensor detects a position only in the radial direction, specifically, in two directions of the X axis and the Y axis orthogonal to each other, and a supporting force is adjusted such that the detected position matches the target position, thereby actively controlling the two-axis direction. The rotor is generally disposed by being separated by a radial gap portion from the stator. The Z axis, which is the axial direction of the bearingless motor of the two-axis control type and is the axis perpendicular to both the X axis and the Y axis, and the inclination direction (θₓ, θ_{y}) are generally not actively controlled, and have a passively stable structure. Hereinafter, a direction in which control is performed is referred to as a control direction. On the other hand, a direction that is passively stable without being controlled is referred to as a passive stability direction. In order to achieve passive stability, the attraction force between the permanent magnet of the rotor and the iron core of the stator is used. In one example, when the rotor is displaced in the axial direction, a magnetic flux flows between the permanent magnet of the rotor and the iron core of the stator separated by the radial gap portion to generate a force for attracting each other, which acts to return the axial displacement of the rotor. As a result, a restoring force is generated in an orientation opposite to the direction of displacement in the axial direction without control. The attraction force acting between the permanent magnet and the iron core is proportional to the distance, and thus can be considered as a spring force. Hereinafter, the ratio of a restoring force [N] to an axial displacement [m] is referred to as a restoring force coefficient k_{z} [N/m].

In the axial direction of the bearingless motor of the two-axis control type, stability is secured using only the restoring force generated in the radial gap portion, and thus stability is poor as compared with the control direction. In addition, the restoring force does not have a function of attenuating vibration. A damping force that is proportional to the speed and has the action of attenuating vibration is not generated in the passive stability direction in principle. For this reason, the vibration in the passive stability direction can be sustained or diverged and become unstable.

Patent Literature 1 proposes a method of performing axial position control of the rotor by applying a field current to the winding of teeth that are the stator facing the rotor by being separated by a radial gap portion. In the technique described in Patent Literature 1, the rotor and the stator have surface portions that do not face each other in the axial direction, a displacement sensor detects the axial position of the rotor, and a control device generates a field current command for performing axial position control of the rotor based on position information detected by the displacement sensor. In the technique described in Patent Literature 1, an axial force is generated in the rotor by a magnetic flux generated by applying a field current to the winding disposed between teeth of the stator protruding toward the rotor and a magnetic flux generated by the permanent magnet.

### CITATION LIST

### Patent Literature

Patent Literature 1: Japanese Patent Application Laid-open No. 2015-171165

### SUMMARY OF INVENTION

### Problem to be Solved by the Invention

Axial position control of the rotor requires an axial displacement sensor or a sensor that measures the speed or acceleration from which displacement can be calculated. Integrating acceleration results in speed, and integrating speed results in displacement. Differentiating displacement results in speed, and differentiating speed results in acceleration. If at least one of the displacement, speed, and acceleration can be detected, the remaining physical quantities can also be computed. In the technique described in Patent Literature 1, a sensor that detects a position using the shaft of the rotor as a sensor target is disposed on the axis end side. In this case, the structure extends in the axial direction by the amount equivalent to the sensor, which increases the volume. In addition, among the two directions in which the shaft extends, on the side on which the sensor is provided, the shaft physically interferes with the sensor, and thus is difficult to connect to a load such as a fan, which is problematic. Furthermore, in the technique described in Patent Literature 1, the use of the sensor as described above is problematic in cost increase due to the use of the sensor, failure of the sensor, disconnection of a signal line connected to the sensor, or increase in fluctuation or error in sensor characteristics due to a change in temperature or the like.

The present disclosure has been made in view of the above, and an object thereof is to provide a control device for a bearingless motor capable of estimating the displacement, speed, or acceleration of the rotor in the axial direction with a simplified structure as compared with the conventional art.

### Means to Solve the Problem

In order to solve the above-described problems and achieve the object, the present disclosure provides a control device for a bearingless motor, the bearingless motor including a rotor and a stator including an electric motor winding that generates torque, the rotor and the stator being disposed with a predetermined gap, the control device being configured to control the bearingless motor, the control device including an observer and a speed estimator. The observer computes at least one of an estimated current or an estimated rotor magnetic flux based on a voltage command value of the electric motor winding or a voltage detection value that is a detection value of a voltage applied to the electric motor winding, the estimated current being an estimated value of a current flowing through the bearingless motor, the estimated rotor magnetic flux being an estimated value of a rotor magnetic flux generated in the electric motor winding by the rotor. The speed estimator calculates and outputs an estimated axial speed that is an estimated value of an axial speed of the rotor in response to input of at least one of a current error or the estimated rotor magnetic flux, the current error being a difference between the estimated current and a current detection value that is a value of a current of the electric motor winding.

### Effects of the Invention

The control device for a bearingless motor according to the present disclosure can achieve the effect of estimating the displacement, speed, or acceleration of the rotor in the axial direction with a simplified structure as compared with the conventional art.

### BRIEF DESCRIPTION OF DRAWINGS

FIG. 1 is a cross-sectional view schematically illustrating an exemplary configuration of a bearingless motor according to the first embodiment.

FIG. 2 is a block diagram illustrating an exemplary configuration of the control device for the bearingless motor according to the first embodiment.

FIG. 3 is a block diagram illustrating an exemplary configuration of the speed estimator that outputs the estimated axial speed in response to input of a current error.

FIG. 4 is a block diagram illustrating an exemplary configuration of the speed estimator that outputs the estimated axial speed in response to input of a current error.

FIG. 5 is a block diagram illustrating an exemplary configuration of the speed estimator that outputs the estimated axial speed in response to input of a current error.

FIG. 6 is a block diagram illustrating an exemplary configuration of the speed estimator that outputs the estimated axial speed in response to input of a current error.

FIG. 7 is a block diagram illustrating an exemplary configuration of the speed estimator that outputs the estimated axial speed in response to input of a current error.

FIG. 8 is a block diagram illustrating an exemplary configuration of the control device for the bearingless motor according to the second embodiment.

FIG. 9 is a block diagram illustrating an exemplary configuration of the d-axis current command value generator in the control device for the bearingless motor according to the third embodiment.

FIG. 10 is a block diagram illustrating an exemplary configuration of the d-axis current command value generator in the control device for the bearingless motor according to the third embodiment.

FIG. 11 is a block diagram illustrating an exemplary configuration of the speed estimator of the control device for the bearingless motor according to the fourth embodiment.

FIG. 12 is a block diagram illustrating an exemplary configuration of the control device for the bearingless motor according to the fourth embodiment.

FIG. 13 is a block diagram illustrating an exemplary configuration of the speed estimator used in the control device for the bearingless motor according to the fourth embodiment.

FIG. 14 is a block diagram illustrating an exemplary configuration of the speed estimator used in the control device for the bearingless motor according to the fourth embodiment.

FIG. 15 is a block diagram illustrating an exemplary configuration of the control device for the bearingless motor according to the fifth embodiment.

FIG. 16 is a block diagram illustrating an exemplary configuration of the control device for the bearingless motor according to the sixth embodiment.

FIG. 17 is a block diagram illustrating an exemplary configuration of hardware for implementing the control device for the bearingless motor according to the first to sixth embodiments.

### DESCRIPTION OF EMBODIMENTS

Hereinafter, a control device for a bearingless motor (or a bearing-less motor), a motor system, and a control method for a bearingless motor according to embodiments of the present disclosure will be described in detail with reference to the drawings.

In the following embodiments, a character indicating a vector is written as “character (vector)”, and a character indicating a matrix is written as “character (matrix)”. In addition, a character written with a symbol on it in a mathematical formula is written as “character (symbol on it)” in the sentence. In one example, a character with “\hat{ }” on it is written as “character\hat{ }”.

### First Embodiment

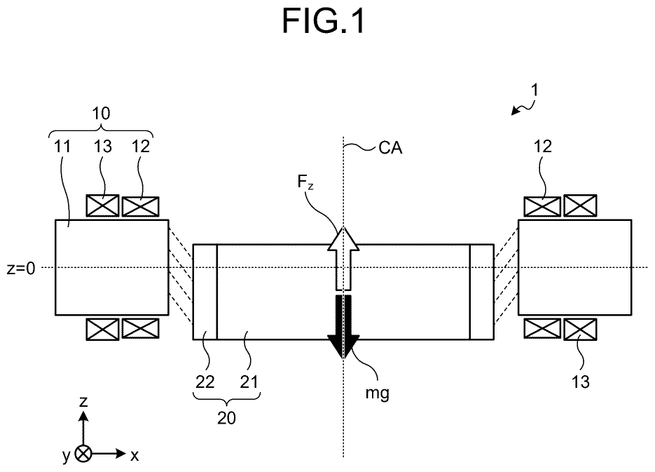

FIG. 1 is a cross-sectional view schematically illustrating an exemplary configuration of a bearingless motor according to the first embodiment. Here, the axial direction of a rotor 20 is defined as the z axis, and two axes perpendicular to each other on a plane which is perpendicular to the z axis are defined as the x axis and the y axis. FIG. 1 illustrates a zx cross section of a bearingless motor 1. The bearingless motor 1 includes a stator 10 and the rotor 20.

The stator 10 includes a stator iron core 11, an electric motor winding 12, and a supporting winding 13. The stator iron core 11 has a substantially cylindrical shape surrounding a central axis CA of the bearingless motor 1. The central axis CA is the center of rotation of the rotor 20 in the bearingless motor 1, and is a virtual straight line passing through the center of the rotor 20 in one example. The central axis CA is an example of a rotation axis. Hereinafter, the extending direction of the central axis CA is also referred to as the axial direction. FIG. 1 illustrates a case where the central axis CA is oriented in the vertical direction. The electric motor winding 12 is a winding for rotation that is provided in a slot of the stator iron core 11 and rotates the rotor 20, that is, generates torque. The supporting winding 13 is a winding for magnetic levitation that is provided in a slot of the stator iron core 11.

The rotor 20 includes a shaft 21 and a permanent magnet 22. In one example, the shaft 21 is a columnar member made of a magnetic material. The shaft 21 has a rotation axis that is the z axis. The diameter of the shaft 21 in the direction perpendicular to the z axis is smaller than the inner diameter of the stator iron core 11. The permanent magnet 22 is disposed on the outer circumference of the shaft 21. The permanent magnet 22 may be fixed to the shaft 21 by magnetic force, or may be fixed by a fixing member such as an adhesive. Although FIG. 1 illustrates the bearingless motor 1 of the surface permanent magnet (SPM) type, in which the permanent magnet 22 is incorporated on the surface of the shaft 21, the bearingless motor 1 may be of the interior permanent magnet (IPM) type, in which the permanent magnet 22 is incorporated inside the iron core of the shaft 21. The stator 10 and the rotor 20 are disposed with a predetermined gap. In this example, the rotor 20 is provided inside the cylindrical stator 10 with a predetermined gap from the inner circumference of the stator 10.

When a current flows through the electric motor winding 12 of the stator 10, a magnetic flux of p poles is generated, and torque occurs. When a current flows through the supporting winding 13 of the stator 10, a magnetic flux of p±2 or two poles is generated, and a supporting force in the radial direction occurs. In the case of a general bearingless motor including a bearingless motor of the surface permanent magnet type or the like, the supporting force is generated by the magnetic field of p±2 poles by the supporting winding 13, and in the case of a bearingless motor of the consequent pole type or a bearingless motor of the homopolar type, the supporting force is generated by the magnetic field of two poles by the supporting winding 13.

At least a part of the magnetic circuit of the magnetic flux of p poles for generating torque and the magnetic circuit of the magnetic flux of p±2 or two poles for generating supporting force is shared. At least a part of the magnetic circuits is shared, and the magnetic flux of p±2 or two poles is superimposed on the magnetic flux of p poles, whereby irregularity occurs in the magnetic flux density. Therefore, the magnitude and the orientation of the supporting force in the radial direction can be controlled by adjusting the magnitude and the phase of the supporting current.

Given that the gravitational acceleration is g and the mass of the rotor 20 is m, an own weight mg always acts downward on the rotor 20. When the rotor 20 exists on the lower side in the axial direction, i.e. on the negative direction side of the z axis, a restoring force F_{z} in the axial direction acts upward from the stator 10. Then, the rotor 20 levitates at a position where the own weight mg and the restoring force F_{z} are balanced. For this reason, as illustrated in FIG. 1, in the arrangement in which the z axis is oriented in the vertical direction, the rotor 20 has a balanced position at the position displaced downward from the magnetic center in the axial direction, that is, the position of z=0. On the other hand, when the rotor 20 is displaced to the upper side in the axial direction, i.e. to the positive direction side of the z axis, the restoring force F_{z} is oriented downward, which is the same as the own weight.

Although not illustrated, a fan or the like may be attached to the rotor 20. At this time, reaction, which is associated with the circulation of air or the like by the fan, acts in the axial direction of the rotor 20. This also changes the axial balanced position of the rotor 20. This reaction occurs even when the axial direction of the rotor 20 is the horizontal direction. Thus, even when the central axis CA of the rotor 20 is along the horizontal direction, the balanced position may deviate from the magnetic center in the axial direction.

Although FIG. 1 illustrates the bearingless motor 1 of the inner rotor type in which the rotor 20 is inside the stator 10, a similar phenomenon occurs also in the outer rotor type in which the rotor 20 is outside the stator 10, and the technology of the embodiments described below can be applied to the bearingless motor 1 of the outer rotor type.

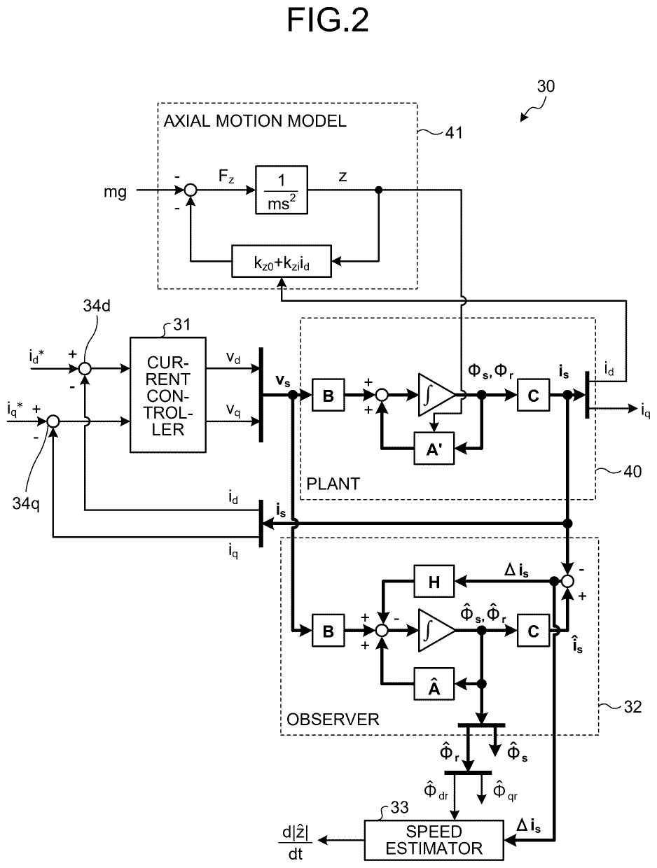

FIG. 2 is a block diagram illustrating an exemplary configuration of the control device for the bearingless motor according to the first embodiment. Here, regarding the bearingless motor 1 as a plant 40 to be controlled, an observer 32 to which a voltage is input and a speed estimator 33 that outputs an estimated axial speed in response to input of a current error are illustrated. A thin line in the drawing means a scalar, and a thick line means a vector, which also applies to the subsequent block diagrams.

The bearingless motor 1 illustrated in FIG. 1 is controlled by a control device 30 illustrated in FIG. 2. The control device 30 includes a current controller 31, the observer 32, and the speed estimator 33. A motor system includes the bearingless motor 1 and the control device 30.

The current controller 31 outputs a voltage command value vₛ* (vector), i.e. a command value of the voltage to be applied to the electric motor winding 12, such that a current detection value detected by a current detector (not illustrated) that detects a current iₛ (vector) flowing through the electric motor winding 12 of the bearingless motor 1 that is the plant 40 matches current command values i_{d}* and i_{q}* for the electric motor winding 12 of the stator 10. In the example of FIG. 2, the voltage command value v_{d} in the d-axis direction and the voltage command value v_{q} in the q-axis direction are output such that the deviation between the d-axis current command value i_{d}*, which is the current command value in the d-axis direction, and a d-axis current i_{d}, which is the output of the plant 40 and the value of the current in the d-axis direction, and the deviation between the q-axis current command value i_{q}*, which is the current command value in the q-axis direction, and a q-axis current i_{q}, which is the output of the plant 40 and the value of the current in the q-axis direction, each become zero. Here, the subscript s means the stator 10. The subscript d means the d-axis, and the subscript q means the q-axis. The superscript * means a command value. The voltage vₛ (vector) input to the observer 32 in FIG. 2 may be a voltage detection value or a voltage command value. The voltage detection value means the value of the voltage applied to the electric motor winding 12 of the stator 10 and detected by a sensor such as a voltage sensor, but a voltage command value may be used without a sensor. In FIG. 2, both the voltage detection value and the voltage command value are simply denoted by vₛ (vector) without the superscript *. The same applies to the other embodiments and drawings for describing the other embodiments.

Based on the voltage command value vₛ* (vector), the observer 32 computes an estimated current iₛ\hat{ } (vector) that is an estimated value of the current flowing through the bearingless motor 1 and/or an estimated rotor magnetic flux Φᵣ\hat{ } (vector) that is an estimated value of a rotor magnetic flux Φᵣ (vector) generated in the electric motor winding 12 by the rotor 10. In the first embodiment, the observer 32 is a calculation model that computes an estimated value of a state variable of the bearingless motor 1 that is the plant 40 in response to input of the voltage command value vₛ* (vector) output from the current controller 31, and estimates the current flowing through the electric motor winding 12 of the bearingless motor 1. That is, the observer 32 is a calculation model that reproduces the operation of the bearingless motor 1. Thus, the output of the observer 32 and the values of current, magnetic flux, and the like which are held as state variables can be computed and estimated without a detector. In addition, it is also possible to compare an estimated value with a detected value to obtain the difference or the like through computation. However, the observer 32 performs estimation and computation assuming that the rotor 20 of the bearingless motor 1 does not move in the axial direction. The current flowing through the electric motor winding 12 estimated by the observer 32 is referred to as the estimated current iₛ\hat{ } (vector), with a hat “\hat{ }” attached thereto. The observer 32 outputs a current error Δiₛ (vector) that is a difference between the estimated current iₛ\hat{ } (vector) and the current detection value iₛ (vector) detected by the current detector.

The speed estimator 33 estimates the axial speed of the rotor 20 in response to input of the current error Δiₛ (vector) and/or the estimated rotor magnetic flux Φᵣ\hat{ } (vector), which is obtained from a value computed by the observer 32. The axial speed estimated by the speed estimator 33 is referred to as an estimated axial speed d|z\hat{ }|/dt.

The position z of the rotor 20 in the axial direction is calculated from the equation of motion of the rotor 20 in the axial direction. This is shown as an axial motion model 41 in FIG. 2. The equation of motion of the rotor 20 in the axial direction is expressed by Formulas (1) and (2) below.

$$\begin{matrix}Formula 1 & \\ m \ddot{z} = {F}_{z} & ( 1 )\end{matrix}$$

$${F}_{z} = - mg - ( {k}_{z 0} + {k}_{z i} {i}_{d} ) z \qquad ( 2 )$$

The ratio of restoring force to displacement is stiffness. The stiffness is a constant value k_{z0} in a case where the current is not controlled, but it is possible to increase or decrease the stiffness by applying the d-axis current i_{d}. In other words, it is possible to increase or decrease the attraction force that is generated between the stator iron core 11 and the permanent magnet 22 of the rotor 20. Here, k_{zi} is a ratio at which the stiffness changes due to the d-axis current i_{d}, and the stiffness at the time of energization is k_{z0}+k_{zi}i_{d}.

The plant 40 to be controlled is the bearingless motor 1. Input is the voltage vₛ (vector)=[v_{d} v_{q}]^{T} and output is the current iₛ (vector)=[i_{d} i_{q}]^{T}. Here, T means transposition.

In addition, a variable that is located between the input and the output of the plant 40 and represents a state is referred to as a state variable. State variables include an armature reaction magnetic flux Φₛ (vector)=[Φ_{ds} Φ_{qs}]^{T} and the rotor magnetic flux Φᵣ (vector)=[Φ_{dr} Φ_{qr}]^{T}. Here, the subscript r means the rotor 20. Since the armature reaction magnetic flux Φₛ (vector) and the rotor magnetic flux Φᵣ (vector) each have two components, the total number of state variables is four.

As expressed by Formula (3) below, the armature reaction magnetic flux Φₛ (vector) and the current iₛ (vector) observed in the electric motor winding 12 of the stator 10 are in a proportional relationship. Therefore, the current iₛ (vector) observed in the electric motor winding 12 may be adopted as a state variable instead of the armature reaction magnetic flux Φₛ (vector), in which case only some elements of the matrix constituting the state equation to be described later are multiplied by a constant of 1/L based on Formula (3) below, and the essence of the equation does not change at all.

$$\begin{matrix}Formula 2 & \\ {Φ}_{s} = {Li}_{s} & ( 3 )\end{matrix}$$

The current iₛ (vector) observed in the electric motor winding 12 of the stator 10 has three phases of U phase, V phase, and W phase, and can be converted into a current on the rotation dq axis through uvw-dq conversion. The equation for converting the U-phase, V-phase, and W-phase current detection values iᵤ, iᵥ, and i_{w} into the d-axis current i_{d} and the q-axis current i_{q} is expressed by Formula (4) below. Here, θ is the angle of the rotation dq axis with respect to the stationary coordinate, that is, the rotation angle.

$$\begin{matrix}Formula 3 & \\ [ \begin{matrix}{i}_{d} \\ {i}_{q}\end{matrix} ] = \sqrt{\frac{2}{3}} [ \begin{matrix}cos θ & cos ( θ - \frac{2 π}{3} ) & cos ( θ - \frac{4 π}{3} ) \\ - sin θ & - sin ( θ - \frac{2 π}{3} ) & - sin ( θ - \frac{4 π}{3} )\end{matrix} ] [ \begin{matrix}{i}_{u} \\ {i}_{v} \\ {i}_{w}\end{matrix} ] & ( 4 )\end{matrix}$$

In a case where the true rotation angle θ is unknown, conversion can be performed using an estimated rotation angle θ\hat{ } which is an estimated value of the rotation angle. In a case where the U-phase, V-phase, and W-phase currents iᵤ, iᵥ, and i_{w} are converted into the d-axis current i_{d} and the q-axis current i_{q} at the estimated rotation angle θ\hat{ }, Formula (5) below is used. Here, the value on the left side is the current value on the estimated d axis and the estimated q axis.

$$\begin{matrix}Formula 4 & \\ [ \begin{matrix}{i}_{d} \\ {i}_{q}\end{matrix} ] = \sqrt{\frac{2}{3}} [ \begin{matrix}cos \hat{θ} & cos ( \hat{θ} - \frac{2 π}{3} ) & cos ( \hat{θ} - \frac{4 π}{3} ) \\ - sin \hat{θ} & - sin ( \hat{θ} - \frac{2 π}{3} ) & - sin ( \hat{θ} - \frac{4 π}{3} )\end{matrix} ] [ \begin{matrix}{i}_{u} \\ {i}_{v} \\ {i}_{w}\end{matrix} ] & ( 5 )\end{matrix}$$

In FIG. 2, the current iₛ (vector) output from the plant 40 is that converted into a current on the dq axis, that is, iₛ (vector)=[i_{d} i_{q}]^{T} is illustrated. Thus, in FIG. 2, illustration of blocks for converting a three-phase current into a dq axis is omitted.

As described above, the current iₛ (vector)=[i_{d} i_{q}]^{T} which is the output of the plant 40 is fed back, and the deviation between the d-axis current command value i_{d}* and the q-axis current command value i_{q}* is computed and input to the current controller 31. The deviation between the d-axis current i_{d} and the d-axis current command value i_{d}* is executed by a current value deviation computation unit 34d, and the deviation between the q-axis current i_{q} and the q-axis current command value i_{q}* is executed by a current value deviation computation unit 34q. Then, the current controller 31 outputs the voltage command value vₛ* (vector)=[v_{d}* v_{q}*]^{T} such that the deviation becomes zero.

The inverter applies a voltage to the plant 40 according to the voltage command value vₛ* (vector). Actually, a voltage is applied to each of the windings of the U phase, the V phase, and the W phase, but in FIG. 2, illustration of the uvw-dq conversion block is omitted, and a dq coordinate value is shown as it is. In FIG. 2, illustration of the inverter is also omitted.

The observer 32 is configured to compute the estimated armature reaction magnetic flux Φₛ\hat{ } (vector) and the estimated rotor magnetic flux Φᵣ\hat{ } (vector), which are estimated values of state variables of the plant 40, in response to input of the voltage vₛ (vector) applied to the stator 10, and estimate, output, and reproduce the current iₛ (vector) flowing through the electric motor winding 12 of the stator 10. The observer 32 calculates the current error Δiₛ (vector) according to Formula (6) below.

$$\begin{matrix}Formula 5 & \\ Δ {i}_{s} = {\hat{ι}}_{s} - {i}_{s} = {[ Δ {i}_{d} Δ {i}_{q} ]}^{T} = {[ {\hat{ι}}_{d} - {i}_{d} {\hat{ι}}_{q} - {i}_{q} ]}^{T} & ( 6 )\end{matrix}$$

As described above, the speed estimator 33 receives input of the current error Δiₛ (vector), and estimates the estimated axial speed d|z\hat{ }|/dt of the rotor 20.

The voltage input to the observer 32 may be the voltage command value vₛ* (vector) or the voltage detection value vₛ (vector). In a case where the voltage command value vₛ* (vector) is input, a voltage sensor is unnecessary, and the structure can be simplified. In a case where the voltage detection value vₛ (vector) is input, the influence of the error between the voltage command value vₛ* (vector) and the voltage detection value vₛ (vector) due to the dead time or the like can be eliminated.

In this manner, the estimated axial speed d|z\hat{ }|/dt of the rotor 20 can be estimated without providing a displacement sensor, a speed sensor, or an acceleration sensor that detects the axial position of the rotor 20. As described above, from the estimated speed, it is also possible to estimate the remaining physical quantities through computation, namely displacement through integration and acceleration through differentiation. In addition, the configuration of inputting the voltage command value vₛ* (vector) to the observer 32 can make a voltage sensor unnecessary. In this case, the only necessary sensor is a current sensor. Thus, it is not necessary to newly provide hardware such as a sensor required for estimating the axial displacement, speed, or acceleration.

Here, processing in the speed estimator 33 will be described. The observer 32 performs estimation assuming that the rotor 20 of the bearingless motor 1 does not move in the axial direction, and the speed estimator 33 obtains the estimated axial speed d|z\hat{ }|/dt from the relational expression between the current error Δiₛ (vector) and the axial speed d|z|/dt, the current error Δiₛ (vector) being the difference between the estimated current iₛ\hat{ }(vector) obtained by the observer 32 and the current iₛ (vector) of the plant 40 including influence of the axial speed d|z|/dt. Details of the calculation of the estimated axial speed d|z\hat{ }|/dt will be described below. The state equation and the output equation of the plant 40 are expressed by Formulas (7) and (8) below, respectively.

$$\begin{matrix}Formula 6 & \\ \frac{d}{dt} [ \begin{matrix}{Φ}_{ds} \\ {Φ}_{qs} \\ {Φ}_{dr} \\ {Φ}_{qr}\end{matrix} ] = [ \begin{matrix}- \frac{R}{L} & {ω}_{1} & \frac{1 d \vert z \vert}{k dt} & {ω}_{r} \\ - {ω}_{1} & - \frac{R}{L} & - {ω}_{r} & \frac{1 d \vert z \vert}{k dt} \\ 0 & 0 & - \frac{1 d \vert z \vert}{k dt} & {ω}_{1} - {ω}_{r} \\ 0 & 0 & {ω}_{r} - {ω}_{1} & - \frac{1 d \vert z \vert}{k dt}\end{matrix} ] [ \begin{matrix}{Φ}_{ds} \\ {Φ}_{qs} \\ {Φ}_{dr} \\ {Φ}_{qr}\end{matrix} ] + [ \begin{matrix}1 & 0 \\ 0 & 1 \\ 0 & 0 \\ 0 & 0\end{matrix} ] [ \begin{matrix}{v}_{d} \\ {v}_{q}\end{matrix} ] & ( 7 )\end{matrix}$$

$$\begin{matrix}Formula 7 & \\ [ \begin{matrix}{i}_{d} \\ {i}_{q}\end{matrix} ] = [ \begin{matrix}\frac{1}{L} & 0 & 0 & 0 \\ 0 & \frac{1}{L} & 0 & 0\end{matrix} ] [ \begin{matrix}{Φ}_{ds} \\ {Φ}_{qs} \\ {Φ}_{dr} \\ {Φ}_{qr}\end{matrix} ] & ( 8 )\end{matrix}$$

Here, in FIG. 2, the matrices in Formulas (7) and (8) are defined as A′ (matrix), B (matrix), and C (matrix) as in Formulas (9), (10), and (11) below.

$$\begin{matrix}Formula 8 & \\ {A}^{′} = [ \begin{matrix}- \frac{R}{L} & {ω}_{1} & \frac{1 d \vert z \vert}{k dt} & {ω}_{r} \\ - {ω}_{1} & - \frac{R}{L} & - {ω}_{r} & \frac{1 d \vert z \vert}{k dt} \\ 0 & 0 & - \frac{1 d \vert z \vert}{k dt} & {ω}_{1} - {ω}_{r} \\ 0 & 0 & {ω}_{r} - {ω}_{1} & - \frac{1 d \vert z \vert}{k dt}\end{matrix} ] & ( 9 )\end{matrix}$$

$$\begin{matrix}Formula 9 & \\ B = [ \begin{matrix}1 & 0 \\ 0 & 1 \\ 0 & 0 \\ 0 & 0\end{matrix} ] & ( 10 )\end{matrix}$$

$$\begin{matrix}Formula 10 & \\ C = [ \begin{matrix}\frac{1}{L} & 0 & 0 & 0 \\ 0 & \frac{1}{L} & 0 & 0\end{matrix} ] & ( 11 )\end{matrix}$$

The variables used in Formulas (7) to (11) are as follows.
Φₛ (vector)=[Φ_{ds} Φ_{qs}]^{T}: armature reaction magnetic flux
Φᵣ (vector)=[Φ_{dr} Φ_{qr}]^{T}: rotor magnetic flux
R: stator resistance
L: inductance
vₛ (vector)=[v_{d} v_{q}]^{T}: voltage input to plant 40
iₛ (vector)=[i_{d} i_{q}]^{T}: current output from plant 40
ω₁: power supply angular frequency
ωᵣ: rotation angular speed (electrical angle) of rotor 20

Here, the inductance L is expressed by L assuming that the d-axis inductance L_{d} and the q-axis inductance L_{q} are equal. The two can be distinguished by denoting L in the first row and the first column of A′ (matrix) in Formula (9) by L_{d} and L in the second row and the second column by L_{q}. In addition, it is considered that the rotor magnetic flux Φᵣ (vector) changes as the rotor 20 is displaced in the axial direction, and k represents the reciprocal of the ratio of the change in the rotor magnetic flux Φᵣ (vector) to the axial displacement.

The state equation and the output equation of the observer 32 are set as in Formulas (12) and (13) below, respectively. Formula (12) is expressed using an estimated rotation angular speed ωᵣ\hat{ } in case that the rotation angular speed ωᵣ of the rotor 20 cannot be detected.

$$\begin{matrix}Formula 11 & \\ \frac{d}{dt} [ \begin{matrix}{\hat{Φ}}_{ds} \\ {\hat{Φ}}_{qs} \\ {\hat{Φ}}_{dr} \\ {\hat{Φ}}_{qr}\end{matrix} ] = [ \begin{matrix}- \frac{R}{L} & {ω}_{1} & 0 & {\hat{ω}}_{r} \\ - {ω}_{1} & - \frac{R}{L} & - {\hat{ω}}_{r} & 0 \\ 0 & 0 & 0 & {ω}_{1} - {\hat{ω}}_{r} \\ 0 & 0 & {\hat{ω}}_{r} - {ω}_{1} & 0\end{matrix} ] [ \begin{matrix}{\hat{Φ}}_{ds} \\ {\hat{Φ}}_{qs} \\ {\hat{Φ}}_{dr} \\ {\hat{Φ}}_{qr}\end{matrix} ] + [ \begin{matrix}1 & 0 \\ 0 & 1 \\ 0 & 0 \\ 0 & 0\end{matrix} ] [ \begin{matrix}{v}_{d} \\ {v}_{q}\end{matrix} ] - [ \begin{matrix}{h}_{11} & {h}_{12} \\ {h}_{21} & {h}_{22} \\ {h}_{31} & {h}_{32} \\ {h}_{41} & {h}_{42}\end{matrix} ] [ \begin{matrix}Δ {i}_{d} \\ Δ {i}_{q}\end{matrix} ] & ( 12 )\end{matrix}$$

$$\begin{matrix}Formula 12 & \\ [ \begin{matrix}{\hat{ι}}_{d} \\ {\hat{ι}}_{q}\end{matrix} ] = [ \begin{matrix}\frac{1}{L} & 0 & 0 & 0 \\ 0 & \frac{1}{L} & 0 & 0\end{matrix} ] [ \begin{matrix}{\hat{Φ}}_{ds} \\ {\hat{Φ}}_{qs} \\ {\hat{Φ}}_{dr} \\ {\hat{Φ}}_{qr}\end{matrix} ] & ( 13 )\end{matrix}$$

Here, in FIG. 2, the matrices in Formulas (12) and (13) are defined as A\hat{ } (matrix) and H (matrix) as in Formulas (14) and (15) below.

$$\begin{matrix}Formula 13 & \\ \hat{A} = [ \begin{matrix}- \frac{R}{L} & {ω}_{1} & 0 & {\hat{ω}}_{r} \\ - {ω}_{1} & - \frac{R}{L} & - {\hat{ω}}_{r} & 0 \\ 0 & 0 & 0 & {ω}_{1} - {\hat{ω}}_{r} \\ 0 & 0 & {\hat{ω}}_{r} - {ω}_{1} & 0\end{matrix} ] & ( 14 )\end{matrix}$$

$$\begin{matrix}Formula 14 & \\ H = [ \begin{matrix}{h}_{11} & {h}_{12} \\ {h}_{21} & {h}_{22} \\ {h}_{31} & {h}_{32} \\ {h}_{41} & {h}_{42}\end{matrix} ] & ( 15 )\end{matrix}$$

If the rotation angular speed ωᵣ can be detected, the detected rotation angular speed ωᵣ may be used. A (matrix) using the rotation angular speed ωᵣ of the rotor 20 in the first row and the fourth column, the second row and the third column, the third row and the fourth column, and the fourth row and the third column of A\hat{ } (matrix) in Formula (14) is expressed as Formula (16) below.

$$\begin{matrix}Formula 15 & \\ A = [ \begin{matrix}- \frac{R}{L} & {ω}_{1} & 0 & {ω}_{r} \\ - {ω}_{1} & - \frac{R}{L} & - {ω}_{r} & 0 \\ 0 & 0 & 0 & {ω}_{1} - {ω}_{r} \\ 0 & 0 & {ω}_{r} - {ω}_{1} & 0\end{matrix} ] & ( 16 )\end{matrix}$$

The variables used in Formulas (12) and (13) are as follows. Note that H (matrix) indicated by Formula (15) represents the feedback gain.
Φₛ\hat{ } (vector)=[Φ_{ds}\hat{ } Φ_{qs}\hat{ }]^{T}: estimated armature reaction magnetic flux
Φᵣ\hat{ } (vector)=[i_{d}\hat{ }i_{qr}\hat{ }]^{T}: estimated rotor magnetic flux
iₛ\hat{ }(vector)=[i_{d}\hat{ } i_{q}\hat{ }]^{T}: estimated current
Δiₛ (vector)=iₛ\hat{ } (vector)−iₛ (vector)
=[Δi_{d} Δi_{q}]^{T}
=[i_{d}\hat{ }−i_{d} i_{q}\hat{ }−i_{q}]^{T}: current error

In Formulas (14) and (16), the first row and the third column, the second row and the fourth column, the third row and the third column, and the fourth row and the fourth column in A\hat{ } (matrix) are set to zero. This is because, unlike the plant 40, the observer 32 performs estimation assuming that the rotor 20 of the bearingless motor 1 does not move in the axial direction.

Here, when the above formulas are transformed and organized, Formula (17) below can be obtained, which indicates the current error Δiₛ (vector).

$$\begin{matrix}Formula 16 & \\ [ \begin{matrix}Δ {i}_{d} \\ Δ {i}_{q}\end{matrix} ] = {C ( {sI}_{4} - A + HC )}^{- 1} [ \begin{matrix}I \\ - I\end{matrix} ] J ( - {Δω}_{r} ) [ \begin{matrix}{\hat{Φ}}_{dr} \\ {\hat{Φ}}_{qr}\end{matrix} ] - {C ( {sI}_{4} - A + HC )}^{- 1} [ \begin{matrix}I \\ - I\end{matrix} ] \frac{1}{k} \frac{d \vert z \vert}{dt} [ \begin{matrix}{Φ}_{dr} \\ {Φ}_{qr}\end{matrix} ] & ( 17 )\end{matrix}$$

Here, s means the time derivative d/dt, and the superscript “−1” means the inverse matrix. In Formula (17), instead of using A\hat{ } (matrix) and A′ (matrix), A (matrix), the rotation angular speed error Δωᵣ, and the estimated axial speed d|z|/dt are used. In addition, the matrices and variables used in Formula (17) are as follows.
I₄ (matrix): 4-by-4 unit matrix
I (matrix): 2-by-2 unit matrix

$$\begin{matrix}Formula 17 & \\ J = [ \begin{matrix}0 & - 1 \\ 1 & 0\end{matrix} ] & \end{matrix}$$

Δωᵣ=ωᵣ\hat{ }−ωᵣ: rotation angular speed error

$${A}^{⌢} = A + [ \begin{matrix}0 & 0 & 0 & {Δω}_{r} \\ 0 & 0 & - {Δω}_{r} & 0 \\ 0 & 0 & 0 & - {Δω}_{r} \\ 0 & 0 & {Δω}_{r} & 0\end{matrix} ] \qquad Formula 18$$

When the d-axis among the dq-axes to be controlled substantially matches the orientation of the N pole of the permanent magnet 22 of the rotor 20, the values of the rotor magnetic flux Φ_{qr} in the q-axis direction and the estimated rotor magnetic flux Φ_{qr}\hat{ } in the q-axis direction can be approximated to zero. In this case, Formula (17) can be further simplified into Formula (18) below.

$$\begin{matrix}Formula 19 & \\ [ \begin{matrix}Δ {i}_{d} \\ Δ {i}_{q}\end{matrix} ] = {C ( {sI}_{4} - A + HC )}^{- 1} [ \begin{matrix}I \\ - I\end{matrix} ] J ( - Δ {ω}_{r} ) [ \begin{matrix}{\hat{Φ}}_{dr} \\ 0\end{matrix} ] - {C ( {sI}_{4} - A + HC )}^{- 1} [ \begin{matrix}I \\ - I\end{matrix} ] \frac{1}{k} \frac{d [ z ]}{dt} [ \begin{matrix}{Φ}_{dr} \\ 0\end{matrix} ] & ( 18 )\end{matrix}$$

As a result, the axial speed d|z|/dt can be estimated as a function of Δi_{d}/Φ_{dr} or Δi_{q}/Φ_{dr}, and the result of the estimation can be output as the estimated axial speed d|z\hat{ }|/dt. Thus, the speed estimator 33 can compute and output the estimated axial speed d|z\hat{ }|/dt by using Formula (18).

The current error Δiₛ (vector) is a function of the estimated rotor magnetic flux Φ_{dr}\hat{ } in the d-axis direction and the rotor magnetic flux Φ_{dr} in the d-axis direction, and these values are theoretically necessary. Here, the estimated rotor magnetic flux Φ_{dr}\hat{ } in the d-axis direction may be used instead of the rotor magnetic flux Φ_{dr} in the d-axis direction. Alternatively, a rotor magnetic flux constant that is a representative constant of the rotor magnetic flux Φᵣ (vector) may be obtained in advance and used instead of the rotor magnetic flux Φ_{dr} in the d-axis direction, and the estimated rotor magnetic flux Φ_{dr}\hat{ } in the d-axis direction that fluctuates during operation may not be used.

Accordingly, since the current error Δiₛ (vector) on the left side of Formula (17) or (18) includes information on the axial speed d|z|/dt on the right side, a relational expression between these two values can be thus clarified. Therefore, it is easy to design a gain coefficient for estimating the axial speed d|z|/dt from the current error Δiₛ (vector).

With regard to the estimation of the estimated axial speed d|z\hat{ }|/dt, the estimated axial speed d|z\hat{ }|/dt is estimated by the speed estimator 33 using the current error Δiₛ (vector), without treating the estimated axial speed d|z\hat{ }|/dt as a state variable. Therefore, the size of the matrix of the plant 40 and the observer 32 does not increase. Thus, the number of state variables can be kept at four, and A (matrix) can be kept at 4×4. Thus, the amount of calculation at the observer 32 is not increased. Accordingly, estimating the estimated axial speed d|z\hat{ }|/dt at the speed estimator 33 achieves an effect that the load of calculation can be reduced and adjustment is facilitated.

A control method for controlling the bearingless motor 1 including the rotor 20 and the stator 10 including the electric motor winding 12 that generates torque includes an observer step and a speed estimation step. In the observer step, the observer 32 computes at least one of the estimated current iₛ\hat{ } (vector) that is an estimated value of the current flowing through the bearingless motor 1 or the estimated rotor magnetic flux Φᵣ\hat{ } (vector) that is an estimated value of the rotor magnetic flux generated in the electric motor winding 12 by the rotor 10 based on the voltage command values v_{d}* and v_{q}* output such that the current detection values i_{d} and i_{q} that are the values of the current of the electric motor winding 12 match the current command values i_{d}* and i_{q}*, or the voltage detection values v_{d} and v_{q} that are the detection values of the voltage applied to the electric motor winding 12. In the speed estimation step, the speed estimator 33 estimates and outputs the estimated axial speed d|z\hat{ }|/dt that is an estimated value of the axial speed of the rotor 20 in response to input of at least one of the current error Li, (vector) that is a difference between the estimated current iₛ\hat{ } (vector) and the current detection value iₛ (vector) or the estimated rotor magnetic flux Φᵣ\hat{ } (vector).

In a case where the voltage detection values v_{d} and v_{q} are not used, the control method for the bearingless motor 1 includes a current detection step and a voltage command value output step. In the current detection step, the current detector of the bearingless motor 1 detects the current of the electric motor winding 12. In the voltage command value output step, the current controller 31 outputs the voltage command values v_{d}* and v_{q}* such that the current detection values i_{d} and i_{q}, which are the values of the current detected by the electric motor winding 12, match the current command values i_{d}* and i_{q}*. The output voltage command values v_{d}* and v_{q}* are used in the observer step. Note that, even in a case where the voltage detection values are used, the current detection step and the voltage command value output step may also be included.

Next, an exemplary configuration of the speed estimator 33 will be described. The estimated current iₛ\hat{ } (vector) and the current detection value iₛ (vector) input to the speed estimator 33 are those converted into d-q axes which are rotational biaxial coordinates. The speed estimator 33 outputs the estimated axial speed d|z\hat{ }|/dt based on at least one of a value obtained by multiplying the d-axis current error Δi_{d} by a predetermined first coefficient or a value obtained by multiplying the q-axis current error Δi_{q} by a predetermined second coefficient.

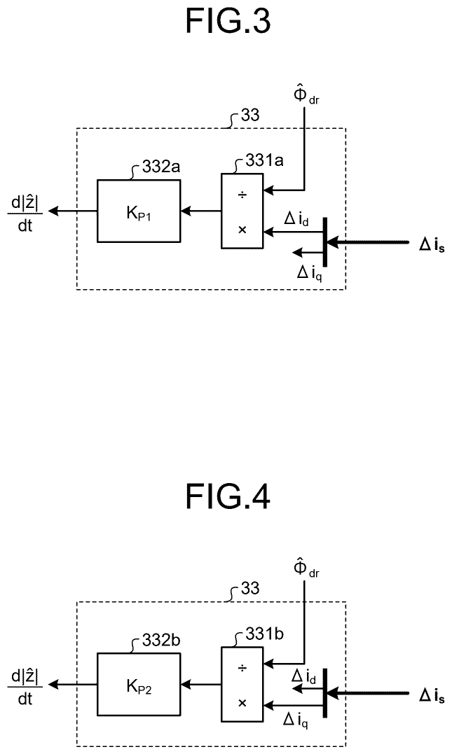

FIGS. 3 to 7 are block diagrams illustrating exemplary configurations of the speed estimator that outputs the estimated axial speed in response to input of a current error. FIG. 3 illustrates the speed estimator 33 in the case of using only the d-axis current error Δi_{d} among the current error Δiₛ (vector)=[Δi_{d} Δi_{q}]^{T}. The speed estimator 33 in this case includes a computation unit 331a and a proportional (P) controller 332a. That is, the computation unit 331a divides the d-axis current error Δi_{d} by the estimated rotor magnetic flux Φ_{dr}\hat{ } in the d-axis direction, and the P controller 332a multiplies the computation result from the computation unit 331a by a P gain K_{P1} that is the first coefficient to output the estimated axial speed d|z\hat{ }|/dt.

FIG. 4 illustrates the speed estimator 33 in the case of using only the q-axis current error Δi_{q} among the current error Δiₛ (vector)=[Δi_{d} Δi_{q}]^{T}. The speed estimator 33 in this case includes a computation unit 331b and a P controller 332b. That is, the computation unit 331b divides the q-axis current error Δi_{q} by the estimated rotor magnetic flux Φ_{dr}\hat{ } in the d-axis direction, and the P controller 332b multiplies the computation result from the computation unit 331b by a P gain K_{P2} that is the second coefficient to output the estimated axial speed d|z\hat{ }|/dt.

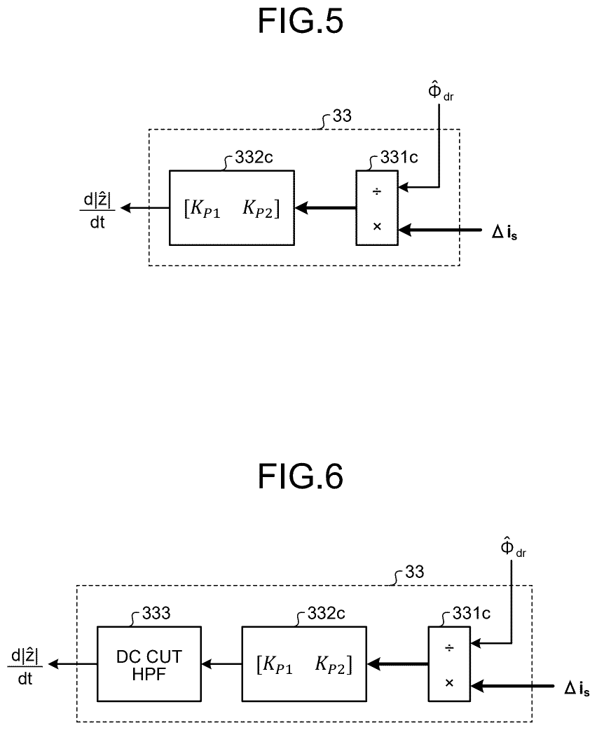

FIG. 5 illustrates the speed estimator 33 in the case of using both components of the current error Li, (vector)=[Δi_{d} Δi_{q}]T. The speed estimator 33 in this case includes a computation unit 331c and a P controller 332c. That is, the computation unit 331c divides the current error Δiₛ (vector) by the estimated rotor magnetic flux Φ_{dr}\hat{ } in the d-axis direction, and the P controller 332c calculates the inner product of the computation result from the computation unit 331c and the P gain matrix [K_{P1} K_{P2}], and outputs the estimated axial speed d|z\hat{ }|/dt. Note that the inner product of the computation result and the P gain matrix is calculated as in Formula (19) below.

Inner product of computation result and P gain

$$matrix = {K}_{P 1} * ( Δ {i}_{d} / {Φ}_{dr} \hat{} ) + {K}_{P 2} * ( Δ {i}_{q} / {Φ}_{dr} \hat{} ) \qquad ( 19 )$$

Note that FIGS. 3 and 4 are equal to the case where one of the P gain matrix [K_{P1} K_{P2}] is set to zero. Thus, the speed estimator 33 illustrated in FIGS. 3 and 4 corresponds to a specific case in the speed estimator 33 in FIG. 5, and the speed estimator 33 illustrated in FIG. 5 includes the speed estimator 33 in FIGS. 3 and 4.

The speed estimator 33 illustrated in FIG. 6 further includes a high-pass filter that excludes only direct-current and low-frequency components compared with the speed estimator 33 in FIG. 5. FIG. 6 illustrates a case where the high-pass filter is a direct current (DC) cut high-pass filter (HPF) 333. What is important of the frequency components of the current error Δiₛ (vector) is the component of the axial vibration frequency of the rotor 20, and the direct-current component is unnecessary. If there is a direct-current component in the current error Δiₛ (vector), the direct-current component also remains in the estimated axial speed d|z\hat{ }|/dt. Therefore, the DC cut HPF 333 removes the direct-current component. In one example, in order to exclude the direct-current component, the DC cut HPF 333 having a cutoff frequency of 1 Hz is used.

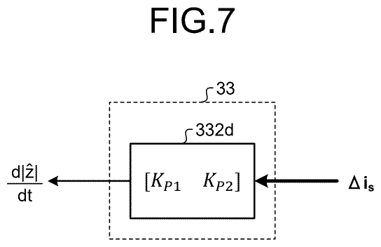

FIG. 7 illustrates the speed estimator 33 in the case of using the current error Δiₛ (vector) as input but not performing division by the estimated rotor magnetic flux Φ_{dr}\hat{ } in the d-axis direction. The speed estimator 33 in this case includes a P controller 332d. The P controller 332d calculates the inner product of the input current error Δiₛ (vector) and the P gain matrix [K_{P1} K_{P2}], and outputs the estimated axial speed d|z\hat{ }|/dt. In this case, the computation corresponding to the division by the estimated rotor magnetic flux Φ_{dr}\hat{ } in the d-axis direction is applied in advance to the P gain matrix [K_{P1} K_{P2}] as a constant. As a result, division computation during operation is avoided, so that the load of calculation is reduced, and a possibility that output becomes unstable due to division by a value close to zero can be avoided.

As described above, in order to calculate the estimated axial speed d|z\hat{ }|/dt, the P controllers 332a to 332d, which are computations of multiplying the current error Δiₛ (vector) by a coefficient, can be used. Normally, in order to estimate speed from displacement information, a derivative (D) controller is required for differential computation. However, differential computation amplifies a high frequency, and thus there is a problem that noise including a frequency higher than the frequency component of a necessary signal is amplified. However, in the first embodiment, the P controllers 332a to 332d are used instead of the D controller, and thus it is possible to prevent amplification of noise including a frequency higher than the frequency component of a necessary signal.

The speed estimator 33 illustrated in FIGS. 3 to 7 sets the coordinate center of the axial position of the rotor 20, that is, z=0, as the center position magnetically facing the stator 10, and outputs the estimated axial speed d|z\hat{ }|/dt corresponding to a value obtained by time-differentiating the absolute value of the axial position. This configuration makes it possible to estimate the speed after determining whether the rotor 20 is away from or approaching the axial center. If a displacement sensor that detects the position of the rotor 20 is used, a signal corresponding to z=0 must be obtained in advance, and post-processing for changing the sign using this value as a boundary must be performed. However, the speed estimator 33 used in the control device 30 for the bearingless motor 1 according to the first embodiment can directly obtain the estimated axial speed d|z\hat{ }|/dt without post-processing. Therefore, adjustment for obtaining a signal corresponding to z=0 in advance is unnecessary.

As described above, the control device 30 for the bearingless motor 1 according to the first embodiment controls the bearingless motor 1 including the rotor 20 and the stator 10 including the electric motor winding 12 that generates torque. The control device 30 for the bearingless motor 1 includes the observer 32 and the speed estimator 33. The observer 32 computes at least one of the estimated current iₛ\hat{ } (vector) or the estimated rotor magnetic flux Φᵣ\hat{ } (vector) of the bearingless motor 1 based on the voltage command value vₛ* (vector) output such that the current detection value iₛ (vector), which is the value of the current of the electric motor winding 12, matches the current command values i_{d}* and i_{q}* or based on the voltage detection value, which is the detection value of the voltage applied to the electric motor winding 12. The speed estimator 33 calculates the estimated axial speed d|z\hat{ }|/dt of the rotor 20 in response to input of at least one of the current error Δiₛ (vector), which is the difference between the estimated current iₛ* (vector) and the current detection value iₛ (vector), or the estimated rotor magnetic flux Φᵣ\hat{ } (vector). The position of the rotor 20 in the axial direction can be obtained using the estimated axial speed d|z\hat{ }|/dt, and a sensor for detecting the axial displacement, speed, or acceleration of the rotor 20 is unnecessary. Thus, compared with a conventional bearingless motor including a sensor that detects the axial displacement, speed, or acceleration of the rotor 20, there is an effect that the axial displacement, speed, or acceleration of the rotor 20 can be estimated with a simplified structure.

### Second Embodiment

In the first embodiment, both the armature reaction magnetic flux Φₛ (vector) or the current iₛ (vector) and the rotor magnetic flux Φᵣ (vector) are used as state variables. However, the state variables can be reduced. In the second embodiment, the control device 30 for the bearingless motor 1 capable of calculating the estimated axial speed d|z\hat{ }|/dt with reduced state variables will be described.

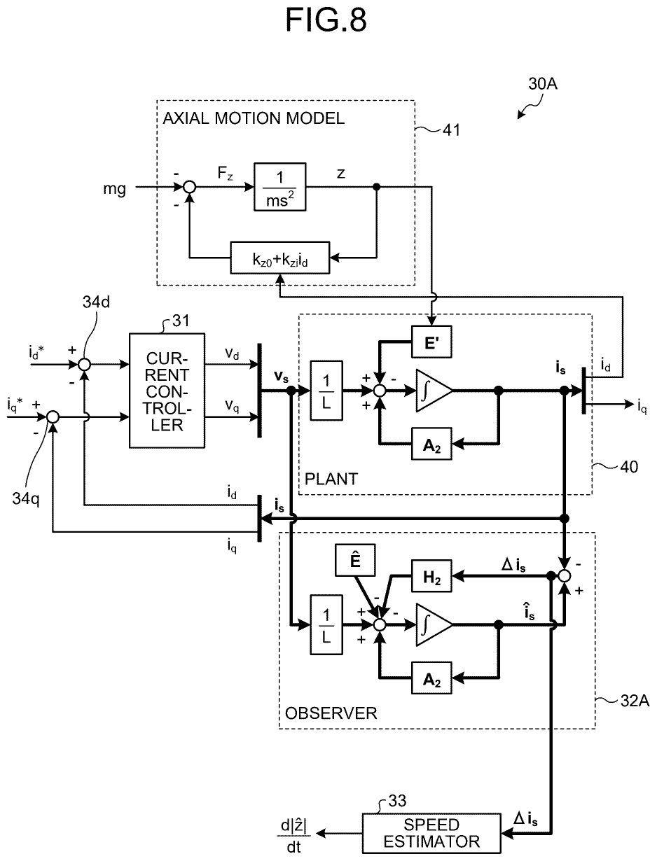

FIG. 8 is a block diagram illustrating an exemplary configuration of the control device for the bearingless motor according to the second embodiment. Here, given that the state variable is only the current, regarding the bearingless motor 1 as the plant 40 to be controlled, the observer 32A to which the voltage vₛ is input and the speed estimator 33 that outputs the estimated axial speed d|z\hat{ }|/dt in response to input of the current error Δiₛ (vector) are illustrated.

The control device 30A for the bearingless motor 1 according to the second embodiment includes the current controller 31, the observer 32A, and the speed estimator 33. The second embodiment is different from the first embodiment in that the observer 32A calculates the estimated current iₛ\hat{ } (vector))=[i_{d}\hat{ } i_{q}\hat{ }]^{T} using the state variable that is the current iₛ (vector). Note that components identical to those in the first embodiment are denoted by the same reference signs, and the description thereof will be omitted.

A method of calculating the estimated axial speed d|z\hat{ }|/dt using the current error Δiₛ (vector) as input will be described. Given that the state variable is only the current iₛ (vector)=[i_{d} i_{q}]^{T}, the state equation and the output equation of the plant 40 are expressed by Formulas (20) and (21) below, respectively.

$$\begin{matrix}Formula 20 & \\ s [ \begin{matrix}{i}_{d} \\ {i}_{q}\end{matrix} ] = [ \begin{matrix}- \frac{R}{L} & {ω}_{1} \\ - {ω}_{1} & - \frac{R}{L}\end{matrix} ] [ \begin{matrix}{i}_{d} \\ {i}_{q}\end{matrix} ] - [ \begin{matrix}cos Δ θ & sin Δ θ \\ - sin Δ θ & cos Δθ\end{matrix} ] \frac{1}{L} [ \begin{matrix}- \frac{1}{k} \frac{d \vert z \vert}{dt} {Φ}_{m} \\ {ω}_{r} {Φ}_{m} ( 1 - \frac{\vert z \vert}{k} )\end{matrix} ] + \frac{1}{L} [ \begin{matrix}{v}_{d} \\ {v}_{q}\end{matrix} ] & ( 20 )\end{matrix}$$

$$\begin{matrix}Formula 21 & \\ [ \begin{matrix}{i}_{d} \\ {i}_{q}\end{matrix} ] = [ \begin{matrix}1 & 0 \\ 0 & 1\end{matrix} ] [ \begin{matrix}{i}_{d} \\ {i}_{q}\end{matrix} ] & ( 21 )\end{matrix}$$

Here, Δθ is a rotation angle error that is a deviation of the estimated rotation angle θ\hat{ } from the rotation angle θ and is represented by θ\hat{ }−θ, and Φₘ is a rotor magnetic flux constant.

When the rotation angle error Δθ is close to zero, supposing that approximations of cos Δθ≈1 and sin Δθ≈Δθ are valid, the state equation of Formula (20) can also be expressed as Formula (22) below.

$$\begin{matrix}Formula 22 & \\ s [ \begin{matrix}{i}_{d} \\ {i}_{q}\end{matrix} ] ≅ [ \begin{matrix}- \frac{R}{L} & {ω}_{1} \\ - {ω}_{1} & - \frac{R}{L}\end{matrix} ] [ \begin{matrix}{i}_{d} \\ {i}_{q}\end{matrix} ] - [ \begin{matrix}1 & Δθ \\ - Δθ & 1\end{matrix} ] \frac{1}{L} [ \begin{matrix}- \frac{1}{k} \frac{d \vert z \vert}{dt} {Φ}_{m} \\ {ω}_{r} {Φ}_{m} ( 1 - \frac{\vert z \vert}{k} )\end{matrix} ] + \frac{1}{L} [ \begin{matrix}{v}_{d} \\ {v}_{q}\end{matrix} ] & ( 22 )\end{matrix}$$

On the other hand, the state equation and the output equation of the observer 32A are set as in Formulas (23) and (24) below.

$$\begin{matrix}Formula 23 & \\ s [ \begin{matrix}{\hat{ι}}_{d} \\ {\hat{ι}}_{q}\end{matrix} ] = [ \begin{matrix}- \frac{R}{L} & {ω}_{1} \\ - {ω}_{1} & - \frac{R}{L}\end{matrix} ] [ \begin{matrix}{\hat{ι}}_{d} \\ {\hat{ι}}_{q}\end{matrix} ] - \frac{1}{L} [ \begin{matrix}0 \\ {ω}_{1} {Φ}_{m}\end{matrix} ] + \frac{1}{L} [ \begin{matrix}{v}_{d} \\ {v}_{q}\end{matrix} ] - \frac{1}{L} [ \begin{matrix}{h}_{11} & {h}_{12} \\ {h}_{21} & {h}_{22}\end{matrix} ] [ \begin{matrix}Δ {i}_{d} \\ Δ {i}_{q}\end{matrix} ] & ( 23 )\end{matrix}$$

$$\begin{matrix}Formula 24 & \\ [ \begin{matrix}{\hat{ι}}_{d} \\ {\hat{ι}}_{q}\end{matrix} ] = [ \begin{matrix}1 & 0 \\ 0 & 1\end{matrix} ] [ \begin{matrix}{\hat{ι}}_{d} \\ {\hat{ι}}_{q}\end{matrix} ] & ( 24 )\end{matrix}$$

Here, in FIG. 8, the matrices in Formulas (22) and (23) are defined as H₂ (matrix), A₂ (matrix), E′ (matrix), and E\hat{ } (matrix) as in Formulas (25) to (28) below. Note that H₂ (matrix) is a matrix indicating the feedback gain.

$$\begin{matrix}Formula 25 & \\ {H}_{2} = [ \begin{matrix}{h}_{11} & {h}_{12} \\ {h}_{21} & {h}_{22}\end{matrix} ] & ( 25 )\end{matrix}$$

$$\begin{matrix}Formula 26 & \\ {A}_{2} = [ \begin{matrix}- \frac{R}{L} & {ω}_{1} \\ - {ω}_{1} & - \frac{R}{L}\end{matrix} ] & ( 26 )\end{matrix}$$

$$\begin{matrix}Formula 27 & \\ {E}^{′} = [ \begin{matrix}1 & Δθ \\ - Δθ & 1\end{matrix} ] \frac{1}{L} [ \begin{matrix}- \frac{1}{k} \frac{d \vert z \vert}{dt} {Φ}_{m} \\ {ω}_{r} {Φ}_{m} ( 1 - \frac{\vert z \vert}{k} )\end{matrix} ] & ( 27 )\end{matrix}$$

$$\begin{matrix}Formula 28 & \\ \hat{E} = \frac{1}{L} [ \begin{matrix}0 \\ {ω}_{1} {Φ}_{m}\end{matrix} ] & ( 28 )\end{matrix}$$

Here, when the above formulas are transformed and organized, Formula (29) below can be obtained, which indicates the current error Δiₛ (vector).

$$\begin{matrix}Formula 29 & \\ [ \begin{matrix}Δ {i}_{d} \\ Δ {i}_{q}\end{matrix} ] = \frac{1}{L} {( {sI}_{2} - {A}_{2} + \frac{1}{L} {H}_{2} )}^{- 1} \{ [ \begin{matrix}- \frac{1}{k} \frac{d \vert z \vert}{dt} {Φ}_{m} \\ - {ω}_{r} {Φ}_{m} \frac{\vert z \vert}{k}\end{matrix} ] + Δ θ [ \begin{matrix}{ω}_{r} {Φ}_{m} ( 1 - \frac{\vert z \vert}{k} ) \\ \frac{1}{k} \frac{d \vert z \vert}{dt} {Φ}_{m}\end{matrix} ] - [ \begin{matrix}0 \\ ( {ω}_{1} - {ω}_{r} ) {Φ}_{m}\end{matrix} ] \} ≅ \frac{1}{L} {( {sI}_{2} - {A}_{2} + \frac{1}{L} {H}_{2} )}^{- 1} \{ [ \begin{matrix}- \frac{1}{k} \frac{d \vert z \vert}{dt} {Φ}_{m} \\ - {ω}_{r} {Φ}_{m} \frac{\vert z \vert}{k}\end{matrix} ] + [ \begin{matrix}{Δθω}_{r} {Φ}_{m} \\ - \frac{d Δθ}{dt} {Φ}_{m}\end{matrix} ] \} & ( 29 )\end{matrix}$$

Here, when Δθ, |z|/k, and (1/k)*d|z|/dt are values close to zero, since Δθ*|z|/k and Δθ*(1/k)*d|z|/dt are very small, the fact that these values are negligible as compared with the other terms is used.

The current error Δiₛ (vector) on the left side of Formula (29) includes a component related to d|z|/dt of the first term on the right side and a component related to the rotation angle error Δθ of the second term. Therefore, the estimated axial speed d|z\hat{ }|/dt and the estimated rotation angle θ\hat{ } can be estimated from the current error Δiₛ (vector).

In the second embodiment, the state variable representing the state of the plant 40 is set to only the current iₛ (vector) observed in the electric motor winding 12 of the stator 10, that is, the d-axis current i_{d} and the q-axis current i_{q}, and a relational expression between the current error Δiₛ (vector) and the axial speed d|z|/dt and the rotation angle θ is formed. Then, the estimated axial speed d|z\hat{ }|/dt and the estimated rotation angle θ\hat{ } are calculated from this relational expression. In this way, setting two state variables achieves an effect that the amount of computation can be reduced as compared with the case of setting four state variables.

### Third Embodiment

In the third embodiment, the control devices 30 and 30A for the bearingless motor 1 further include a d-axis current command value generator that generates the d-axis current command value i_{d}*. The d-axis current command value generator generates the d-axis current command value i_{d}* using the estimated axial speed d|z\hat{ }|/dt output from the speed estimator 33, and outputs the d-axis current command value i_{d}* to the current controller 31.

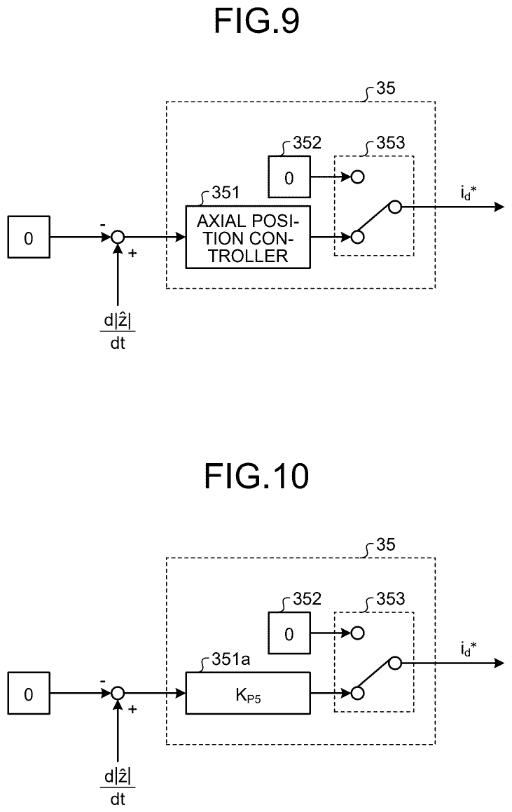

FIG. 9 is a block diagram illustrating an exemplary configuration of the d-axis current command value generator in the control device for the bearingless motor according to the third embodiment. The d-axis current command value generator 35 receives input of the estimated axial speed d|z\hat{ }|/dt from the speed estimator 33, and outputs the d-axis current command value i_{d}*. The d-axis current command value generator 35 includes an axial position controller 351, a zero-value output unit 352, and a switch 353. The axial position controller 351 outputs the d-axis current command value i_{d}* from the estimated axial speed d|z\hat{ }|/dt. The zero-value output unit 352 outputs zero as the d-axis current command value i_{d}*. The switch 353 selects one of the output of the axial position controller 351 or the output from the zero-value output unit 352, and outputs the selected output as the d-axis current command value i_{d}*. The zero-value output unit 352 is used when the d-axis current command value i_{d}* can be set to zero. In FIG. 9, the axial position controller 351 is configured to output the d-axis current command value i_{d}* in response to input of the estimated axial speed d|z\hat{ }|/dt so as to enable adjustment of the d-axis current.

The d-axis current command value generator 35 may be configured to give a command of a positive d-axis current when the estimated axial speed d|z\hat{ }|/dt is a positive value, and give a command of a negative d-axis current when the estimated axial speed d|z\hat{ }|/dt is a negative value. A representative controller that outputs such a command is a P controller. FIG. 10 is a block diagram illustrating an exemplary configuration of the d-axis current command value generator in the control device for the bearingless motor according to the third embodiment. FIG. 10 illustrates a case where a P controller 351a is used as the axial position controller 351. The P gain of the P controller 351a is denoted by K_{P5}. By setting K_{P5} to a positive value, the signs of the input and the output can be matched.

The axial position controller 351 is not limited to the P controller 351a that simply makes the output proportional to the input. A sgn (signum) function which is a function that outputs 1 when the value of the input is positive and outputs −1 when the value of the input is negative may be used, or the sgn function may be used in combination with the P controller 351a. Further, a limiter may be applied to the value of the input. Furthermore, a third power value of the input may be used.

Applying the P controller 351a to the axial position controller 351, suppose that a condition that the d-axis current i_{d} is K_{P5} times the estimated axial speed d|z\hat{ }|/dt and the estimated axial speed d|z\hat{ }|/dt is equal to the axial speed d|z|/dt is satisfied. At this time, the equation of motion in the axial direction is as in Formula (30) below.

$$\begin{matrix}Formula 30 & \\ {F}_{z} = - mg - ( {k}_{z 0} + {k}_{zi} {K}_{P 5} \frac{d \vert z \vert}{dt} ) z & ( 30 )\end{matrix}$$

Here, given z≥0, Formula (31) below holds, and k_{zi}Kₚ₅z>0 is valid. Here, given z<0, Formula (32) below holds, and k_{zi}Kₚ₅(−z)>0 is valid.

$$\begin{matrix}Formula 31 & \\ {F}_{z} = - mg - {k}_{z 0} z - {k}_{zi} {K}_{P 5} z \dot{z} & ( 31 )\end{matrix}$$

$$\begin{matrix}Formula 32 & \\ {F}_{z} = - mg - {k}_{z 0} z - {k}_{zi} {K}_{P 5} ( - z ) \dot{z} & ( 32 )\end{matrix}$$

As described above, a force can be generated in proportion to the axial speed d|z|/dt and in an orientation opposite to the direction of the speed. This corresponds to a damping force that attenuates vibration. Thus, by generating the d-axis current command value i_{d}* from the estimated axial speed d|z\hat{ }|/dt output from the speed estimator 33, it is possible to generate a damping force that attenuates vibration when the rotor 20 vibrates in the axial direction.

In the third embodiment, the control measure for the bearingless motor 1 includes the d-axis current command value generator 35 that outputs the d-axis current command value i_{d}* in response to input of the estimated axial speed d|z\hat{ }|/dt, or the d-axis current command value generator 35 that gives a command of the positive d-axis current command value i_{d}* if the estimated axial speed d|z\hat{ }|/dt is a positive value and gives a command of the negative d-axis current command value i_{d}* if the estimated axial speed d|z\hat{ }|/dt is a negative value. Consequently, d-axis current i_{d} of the electric motor winding 12 can be increased or decreased in accordance with the axial vibration of the rotor 20. As a result, an axial attraction force can be generated between the stator 10 and the rotor 20 so that axial vibration of the rotor 20 is attenuated. In addition, this control, for which a device such as a thrust magnetic bearing is not newly added, achieves an effect that the structure is compact and the stability in the axial direction, which is supposed to be the original passive stability direction of the bearingless motor 1 of the two-axis control type, can be improved without increasing the cost.

### Fourth Embodiment

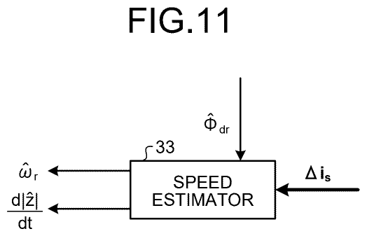

FIG. 11 is a block diagram illustrating an exemplary configuration of the speed estimator of the control device for the bearingless motor according to the fourth embodiment. In the fourth embodiment, the speed estimator 33 receives input of the current error Δiₛ (vector), and outputs the estimated axial speed d|z\hat{ }|/dt and the estimated rotation angular speed ωᵣ\hat{ }. In Formula (17) representing the current error Δiₛ (vector) described in the first embodiment, the first term on the right side represents the rotation angular speed error Δωᵣ, and the second term on the right side represents the axial speed d|z|/dt. Thus, the current error Δiₛ (vector) has information of both the rotation angular speed error Δωᵣ and the axial speed d|z|/dt. Therefore, not only the axial speed d|z|/dt but also the rotation angular speed ωᵣ can be estimated from the current error Δiₛ (vector).

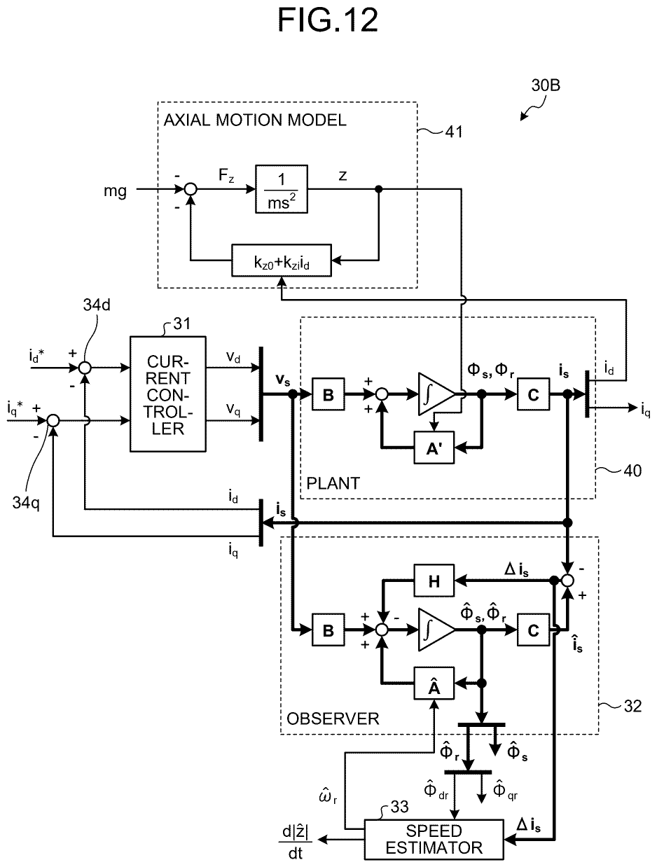

FIG. 12 is a block diagram illustrating an exemplary configuration of the control device for the bearingless motor according to the fourth embodiment. Note that components identical to those described in FIG. 2 are denoted by the same reference signs, and the description thereof will be omitted. The control device 30B for the bearingless motor 1 in FIG. 12 illustrates a case where the estimated rotation angular speed ωᵣ\hat{ } estimated by the speed estimator 33 is used by the observer 32. That is, the observer 32 does not use the signal of the rotation angular speed sensor, and uses the value of the estimated rotation angular speed ωᵣ\hat{ } output from the speed estimator 33 instead of the rotation angular speed ωᵣ.

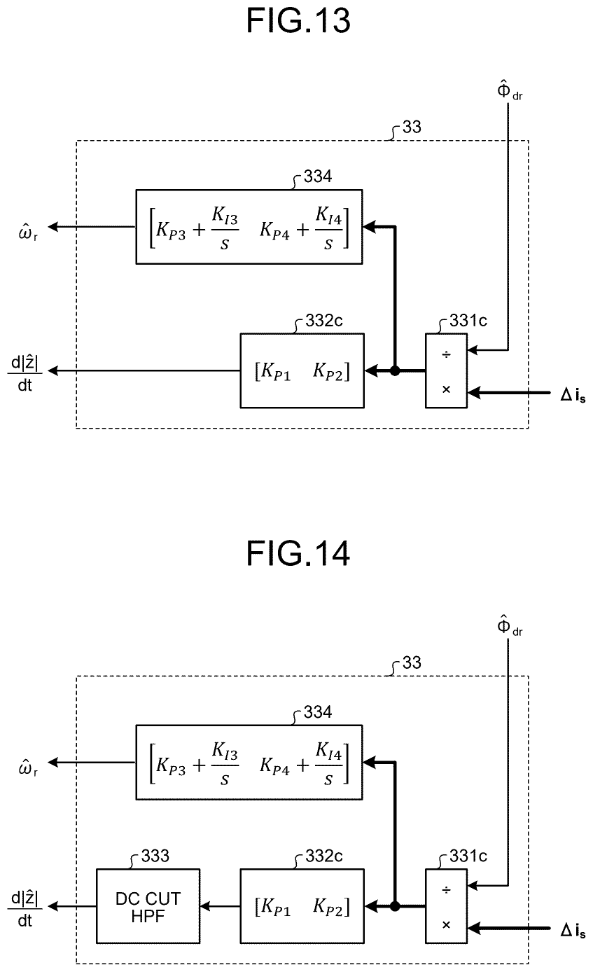

Next, an exemplary configuration of the speed estimator 33 used in the fourth embodiment will be described. FIG. 13 is a block diagram illustrating an exemplary configuration of the speed estimator used in the control device for the bearingless motor according to the fourth embodiment. The speed estimator 33 includes a computation unit 331c, a P controller 332c, and a PI controller 334. That is, the computation unit 331c divides the current error Δiₛ (vector) by the estimated rotor magnetic flux Φ_{dr}\hat{ } in the d-axis direction. The computation unit 331c outputs the result of the division to the P controller 332c and the PI controller 334. The processing in the P controller 332c is similar to that described in FIG. 5 of the first embodiment, and thus the description thereof will be omitted.

The PI controller 334 calculates the inner product of the computation result from the computation unit 331c and the PI gain matrix [K_{P3}+K_{I3}/s K_{P4}+K_{I4}/S], and outputs an estimated rotation angular speed ωᵣ\hat{ }. The PI controller 334 also performs an integration computation. A term such as K_{I3}/s of the PI gain matrix corresponds to the integration computation. That is, 1/s in this term represents the integration computation, and K_{I3} and K_{I4} represent gains of the integration. The PI controller 334 amplifies and feeds back the direct-current component. When the direct-current component of the current error Δiₛ (vector) is not zero, the estimated rotation angular speed ωᵣ\hat{ } changes, and the estimated rotation angular speed ωᵣ\hat{ } approaches the rotation angular speed ωᵣ. At the same time, the direct-current component of the current error Δiₛ (vector) approaches zero to make a steady state. Therefore, it is possible to match the estimated rotation angular speed ωᵣ\hat{ } with the rotation angular speed ωᵣ.

In order to converge the rotation angular speed error Δωᵣ, from direct-current components to low-frequency components of Δωᵣ included in the current error Δiₛ (vector) are important. In order to converge the axial speed d|z|/dt, from medium-frequency components to high-frequency components close to the natural angular frequency in the axial direction corresponding to the variation of the axial speed d|z|/dt and included in the current error Δiₛ (vector) are important. Therefore, information of the rotation angular speed ωᵣ can be extracted by amplifying the direct-current component of the current error Δiₛ (vector), and information of the axial speed d|z|/dt can be extracted by not amplifying the direct-current component. Thus, the rotation angular speed ωᵣ and the axial speed d|z|/dt can be separately fed back.

FIG. 14 is a block diagram illustrating an exemplary configuration of the speed estimator used in the control device for the bearingless motor according to the fourth embodiment. Note that components identical to those in FIG. 13 are denoted by the same reference signs, and the description thereof will be omitted. The speed estimator 33 illustrated in FIG. 14 further includes the DC cut HPF 333 which is a high-pass filter that excludes only direct-current and low-frequency components and is disposed at the subsequent stage of the P controller 332c in FIG. 13. By adding the DC cut HPF 333 to the detection block of the estimated axial speed d|z\hat{ }|/dt in this manner, the direct-current component can be excluded from the estimated axial speed d|z\hat{ }|/dt, and the rotation angular speed ωᵣ and the axial speed d|z|/dt can be accurately separated and estimated.

In the fourth embodiment, the speed estimator 33 outputs the estimated axial speed d|z\hat{ }|/dt and the estimated rotational angular speed ωᵣ\hat{ } from the current error Δiₛ (vector). Thus, not only the estimated axial speed d|z\hat{ }|/dt of the rotor 20 but also the angle of the rotor 20 can be simultaneously estimated from the current error Δiₛ (vector). By estimating the angle of the rotor 20 from the current, it is possible to perform the rotation control and the levitation control of the bearingless motor 1 without using the signal of the angle sensor. As a result, it is possible to solve the problem that the noise of the angle sensor generated during the operation of the bearingless motor 1 including the angle sensor affects the control. In addition, it is possible to avoid a change in characteristics of the angle sensor due to a phase delay of an angle sensor signal low-pass filter (LPF) that is used for noise countermeasures and excludes a high frequency component, a temperature change, and the like, and it is possible to avoid a problem that occurs in a detection signal from the angle sensor, such as disconnection of a signal line. Furthermore, from the same input of the current error Δiₛ (vector), the estimated rotation angular speed ωᵣ\hat{ } can be estimated by amplifying the direct-current component, and the estimated axial speed d|z\hat{ }|/dt can be estimated by not amplifying the direct-current component. Thus, the estimated rotation angular speed ωᵣ\hat{ } and the estimated axial speed d|z\hat{ }|/dt can be simultaneously separated and fed back.

### Fifth Embodiment

In the first embodiment, both the armature reaction magnetic flux Φₛ (vector) or the current iₛ (vector) and the rotor magnetic flux Φᵣ (vector) are used as state variables. However, it is also possible to use only the rotor magnetic flux Φᵣ (vector) as the state variable. In the fifth embodiment, the control device 30 for the bearingless motor 1 capable of calculating the estimated axial speed d|z\hat{ }|/dt with the reduced state variable that is only the rotor magnetic flux Φᵣ (vector) will be described.

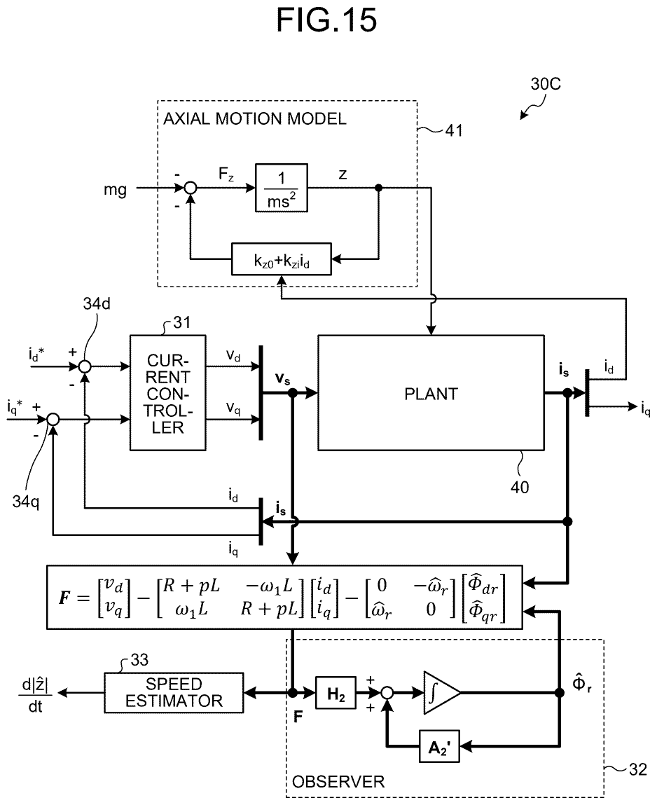

FIG. 15 is a block diagram illustrating an exemplary configuration of the control device for the bearingless motor according to the fifth embodiment. Here, given that the state variable is only the rotor magnetic flux Φᵣ (vector), regarding the bearingless motor 1 as the plant 40 to be controlled, FIG. 15 illustrates the observer 32 to which the voltage vₛ (vector) is input and the speed estimator 33 that outputs the estimated axial speed d|z\hat{ }|/dt in response to input of the rotor magnetic flux error. In the control device 30C for the bearingless motor 1 in FIG. 15, components identical to those in the first embodiment are denoted by the same reference signs.

A method of calculating the estimated axial speed d|z\hat{ }|/dt will be described. Given that the state variable is only the rotor magnetic flux Φᵣ (vector), the state equation of the plant 40 is expressed by Formulas (33) and (34) below.

$$\begin{matrix}Formula 33 & \\ \frac{d}{dt} [ \begin{matrix}{Φ}_{dr} \\ {Φ}_{qr}\end{matrix} ] + [ \begin{matrix}0 & - {ω}_{1} \\ {ω}_{1} & 0\end{matrix} ] [ \begin{matrix}{Φ}_{dr} \\ {Φ}_{qr}\end{matrix} ] = [ \begin{matrix}- \frac{1}{k} \frac{d \vert z \vert}{dt} & - {ω}_{r} \\ {ω}_{r} & - \frac{1}{k} \frac{d \vert z \vert}{dt}\end{matrix} ] [ \begin{matrix}{Φ}_{dr} \\ {Φ}_{qr}\end{matrix} ] & ( 33 )\end{matrix}$$

$$\begin{matrix}Formula 34 & \\ [ \begin{matrix}{v}_{d} \\ {v}_{q}\end{matrix} ] = [ \begin{matrix}R + pL & - {ω}_{1} L \\ {ω}_{1} L & R + pL\end{matrix} ] [ \begin{matrix}{i}_{d} \\ {i}_{q}\end{matrix} ] + [ \begin{matrix}- \frac{1}{k} \frac{d \vert z \vert}{dt} & - {ω}_{r} \\ {ω}_{r} & - \frac{1}{k} \frac{d \vert z \vert}{dt}\end{matrix} ] [ \begin{matrix}{Φ}_{dr} \\ {Φ}_{qr}\end{matrix} ] & ( 34 )\end{matrix}$$

Next, the observer 32 is constructed as in Formula (35) below.

$$\begin{matrix}Formula 35 & \\ \frac{d}{dt} [ \begin{matrix}{\hat{Φ}}_{dr} \\ {\hat{Φ}}_{qr}\end{matrix} ] = [ \begin{matrix}0 & {ω}_{1} - {\hat{ω}}_{r} \\ - {ω}_{1} + {\hat{ω}}_{r} & 0\end{matrix} ] [ \begin{matrix}{\hat{Φ}}_{dr} \\ {\hat{Φ}}_{qr}\end{matrix} ] + {H}_{2} \{ [ \begin{matrix}{v}_{d} \\ {v}_{q}\end{matrix} ] - [ \begin{matrix}R + pL & - {ω}_{1} L \\ {ω}_{1} L & R + pL\end{matrix} ] [ \begin{matrix}{i}_{d} \\ {i}_{q}\end{matrix} ] - [ \begin{matrix}0 & - {\hat{ω}}_{r} \\ {\hat{ω}}_{r} & 0\end{matrix} ] [ \begin{matrix}{\hat{Φ}}_{dr} \\ {\hat{Φ}}_{qr}\end{matrix} ] \} = {A}_{2}^{′} [ \begin{matrix}{\hat{Φ}}_{dr} \\ {\hat{Φ}}_{qr}\end{matrix} ] + {H}_{2} F & ( 35 )\end{matrix}$$

Here, in FIG. 15, determinants in Formula (35) are defined as A₂′ (matrix) and F (matrix) as in Formulas (36) and (37) below.

$$\begin{matrix}Formula 36 & \\ {A}_{2}^{′} = [ \begin{matrix}0 & {ω}_{1} - {\hat{ω}}_{r} \\ - {ω}_{1} + {\hat{ω}}_{r} & 0\end{matrix} ] & ( 36 )\end{matrix}$$

$$\begin{matrix}Formula 37 & \\ F = [ \begin{matrix}{v}_{d} \\ {v}_{q}\end{matrix} ] - [ \begin{matrix}R + pL & - {ω}_{1} L \\ {ω}_{1} L & R + pL\end{matrix} ] [ \begin{matrix}{i}_{d} \\ {i}_{q}\end{matrix} ] - [ \begin{matrix}0 & - {\hat{ω}}_{r} \\ {\hat{ω}}_{r} & 0\end{matrix} ] [ \begin{matrix}{\hat{Φ}}_{dr} \\ {\hat{Φ}}_{qr}\end{matrix} ] & ( 37 )\end{matrix}$$

The right side of Formula (35) does not include the rotor magnetic flux Φᵣ (vector) that is difficult to be directly measured, and all values included in Formula (35) are known values or values computed during operation. Therefore, the estimated rotor magnetic flux [(Φ_{dr}\hat{ } Φ_{qr}\hat{ }]^{T} can be computed by using this formula. Here, the right side on F (matrix) in Formula (37) is transformed into Formula (38) below.

$$\begin{matrix}Formula 38 & \\ \begin{matrix}F = [ \begin{matrix}- \frac{1}{k} \frac{d \vert z \vert}{dt} & - {ω}_{r} \\ {ω}_{r} & - \frac{1}{k} \frac{d \vert z \vert}{dt}\end{matrix} ] [ \begin{matrix}{Φ}_{dr} \\ {Φ}_{qr}\end{matrix} ] - [ \begin{matrix}0 & - {\hat{ω}}_{r} \\ {\hat{ω}}_{r} & 0\end{matrix} ] [ \begin{matrix}{\hat{Φ}}_{dr} \\ {\hat{Φ}}_{qr}\end{matrix} ] \\ = - \frac{1}{k} \frac{d \vert z \vert}{dt} [ \begin{matrix}{Φ}_{dr} \\ {Φ}_{qr}\end{matrix} ] + [ \begin{matrix}{\hat{ω}}_{r} {\hat{Φ}}_{qr} - {ω}_{r} {Φ}_{qr} \\ - {\hat{ω}}_{r} {\hat{Φ}}_{dr} + {ω}_{r} {Φ}_{dr}\end{matrix} ]\end{matrix} & ( 38 )\end{matrix}$$

Given Φ_{qr}≈0, Φ_{qr}\hat{ }≈0, and Φ_{dr}≈Φ_{dr}\hat{ }, Formula (38) turns into Formula (39) below.

$$\begin{matrix}Formula 39 & \\ F ≅ - \frac{1}{k} \frac{d \vert z \vert}{dt} [ \begin{matrix}{\hat{Φ}}_{dr} \\ 0\end{matrix} ] - ( {\hat{ω}}_{r} - {ω}_{r} ) [ \begin{matrix}0 \\ {\hat{Φ}}_{dr}\end{matrix} ] & ( 39 )\end{matrix}$$

Therefore, after the observer 32 is constructed so that [Φ_{dr}\hat{ } Φ_{qr}\hat{ }]^{T} can be computed, it is possible to construct the speed estimator 33 that receives input of F (matrix) expressed by Formula (37) that is a function including the estimated rotor magnetic flux [Φ_{dr}\hat{ } Φ_{qr}\hat{ }]^{T}. By using F (matrix) as input, the value of the estimated axial speed d|z\hat{ }|/dt can be estimated, and the value of the rotation angular speed error Δωᵣ=ωᵣ\hat{ }−ωᵣ can be estimated.

In the fifth embodiment, the state variable representing the state of the plant 40 is only the rotor magnetic flux Φᵣ (vector), and the function including the axial speed d|z|/dt and the rotation angular speed error Δωᵣ is input to the speed estimator 33. Consequently, as in the second embodiment, since the two state variables are used, the amount of computation can be reduced as compared with the case of four state variables. In addition, a differential computation for estimating the estimated axial speed d|z\hat{ }|/dt can be made unnecessary.

### Sixth Embodiment

In examples described in the first to fifth embodiments, the control device 30 for the bearingless motor 1 includes the speed estimator 33 that calculates and outputs the estimated axial speed that is an estimated value of the axial speed of the rotor 20 in response to input of at least one of the current error Δiₛ (vector) that is the difference between the estimated current iₛ\hat{ } (vector) and the current detection value iₛ (vector) or the estimated rotor magnetic flux Φᵣ\hat{ } (vector). However, the d-axis current command value i_{d}* may be directly calculated from at least one of the current error Δiₛ (vector) or the estimated rotor magnetic flux Φᵣ\hat{ } (vector), without calculating the estimated axial speed d|z\hat{ }|/dt as an intermediate variable.

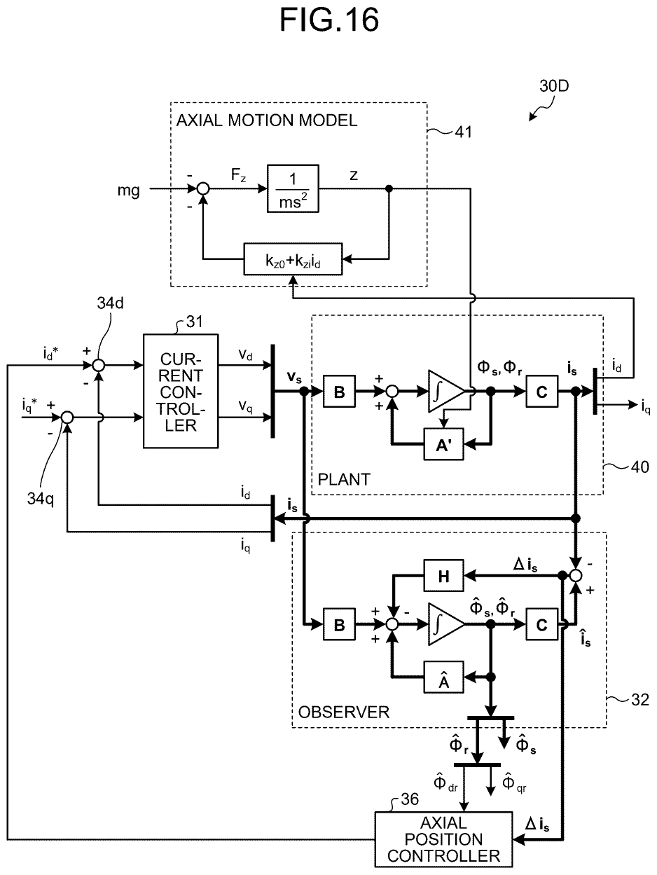

FIG. 16 is a block diagram illustrating an exemplary configuration of the control device for the bearingless motor according to the sixth embodiment. Note that components identical to those described in FIG. 2 are denoted by the same reference signs, and the description thereof will be omitted. The control device 30D for the bearingless motor 1 in FIG. 16 includes an axial position controller 36 instead of the speed estimator 33. The axial position controller 36 computes and outputs the d-axis current command value i_{d}* for controlling the axial position of the rotor 20 from at least one of the current error Δiₛ (vector) or the estimated rotor magnetic flux Φᵣ\hat{ } (vector), which is obtained from a value computed by the observer 32. The axial position controller 36 outputs the computed d-axis current command value i_{d}* to the current value deviation computation unit 34d.

Although FIG. 16 illustrates the case where the control device 30 for the bearingless motor 1 in the first embodiment includes the axial position controller 36 instead of the speed estimator 33, the control devices 30A, 30B, and 30C for the bearingless motor 1 in the second to fifth embodiments may include the axial position controller 36 instead of the speed estimator 33.

The control device 30 for the bearingless motor 1 in the sixth embodiment includes the axial position controller 36 that computes the d-axis current command value i_{d}* from at least one of the current error Δiₛ (vector) or the estimated rotor magnetic flux Φᵣ\hat{ } (vector) and outputs the d-axis current command value i_{d}*. Consequently, the d-axis current command value i_{d}* corresponding to the axial displacement, speed, or acceleration of the rotor 20 can be directly computed.

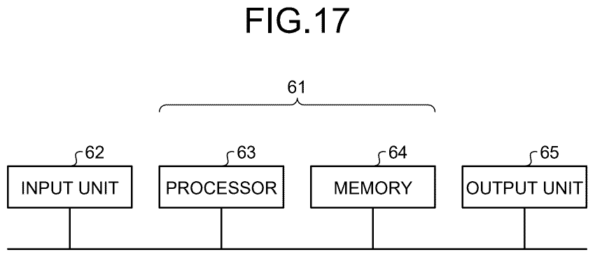

FIG. 17 is a block diagram illustrating an exemplary configuration of hardware for implementing the control device for the bearingless motor according to the first to sixth embodiments. FIG. 17 is an exemplary configuration in the case that the current controller 31, the observers 32 and 32A, the speed estimator 33, the axial position controller 36, and the d-axis current command value generator 35, which are main parts of the control devices 30, 30A, 30B, 30C, and 30D for the bearingless motor 1, are implemented by processing circuitry 61 including a processor 63 and a memory 64.

The processor 63 is a central processing unit (CPU). The processor 63 executes a control program. The control program is a program describing processing for operating the processing circuitry 61 as the current controller 31, the observers 32 and 32A, the speed estimator 33, the axial position controller 36, and the d-axis current command value generator 35, which are main parts of the control devices 30, 30A, 30B, 30C, and 30D for the bearingless motor 1.

The memory 64 is, in one example, a volatile or non-volatile memory such as a random access memory (RAN), a read only memory (ROM), a flash memory, an erasable programmable ROM (EPROM), or an electrically erasable programmable ROM (EEPROM, registered trademark). The memory 64 stores a control program. The memory 64 is also used as a temporary memory when the processor 63 executes various processes.

An input unit 62 is a circuit that receives input signals to the control devices 30, 30A, 30B, 30C, and 30D from the outside. An output unit 65 is a circuit that outputs signals generated by the control devices 30, 30A, 30B, 30C, and 30D to the outside of the control devices 30, 30A, 30B, 30C, and 30D.

The function of the processing circuitry 61 may be implemented by processing circuitry that is dedicated hardware. The processing circuitry that is dedicated hardware is, for example, an application specific integrated circuit (ASIC), a field-programmable gate array (FPGA), or a circuit that is a combination thereof. A part of the main parts of the control devices 30, 30A, 30B, 30C, and 30D for the bearingless motor 1 may be implemented by the processor 63 and the memory 64, and the rest may be implemented by dedicated hardware.

The configurations described in the above-mentioned embodiments indicate examples. The embodiments can be combined with another well-known technique and with each other, and some of the configurations can be omitted or changed in a range not departing from the gist.

### REFERENCE SIGNS LIST

1 bearingless motor; 10 stator; 11 stator iron core; 12 electric motor winding; 13 supporting winding; 20 rotor; 21 shaft; 22 permanent magnet; 30, 30A, 30B, 30C, 30D control device; 31 current controller; 32, 32A observer; 33 angular speed estimator; 34d, 34q current value deviation computation unit; 35 d-axis current command value generator; 36, 351 axial position controller; 40 plant; 41 axial motion model; 61 processing circuitry; 62 input unit; 63 processor; 64 memory; 65 output unit; 331a, 331b, 331c computation unit; 332a, 332b, 332c, 332d, 351a P controller; 333 DC cut HPF; 334 PI controller; 352 zero-value output unit; 353 switch.

1. A control device for a bearingless motor, the bearingless motor including a rotor and a stator including an electric motor winding that generates torque, the rotor and the stator being disposed with a predetermined gap, the control device being configured to control the bearingless motor, the control device comprising:
observing circuitry to compute an estimated current based on a voltage command value of the electric motor winding or a voltage detection value that is a detection value of a voltage applied to the electric motor winding, the estimated current being an estimated value of a current flowing through the bearingless motor; and
speed estimating circuitry to calculate and output an estimated axial speed that is an estimated value of an axial speed of the rotor in response to input of a current error, the current error being a difference between the estimated current and a current detection value that is a value of a current of the electric motor winding.

2. The control device for the bearingless motor according to claim 1, wherein
the estimated current and the current detection value are those converted into d-q axes that are rotational biaxial coordinates, and
the speed estimating circuitry outputs the estimated axial speed based on at least one of a value obtained by multiplying the current error in the d axis by a predetermined first coefficient or a value obtained by multiplying the current error in the q axis by a predetermined second coefficient.

3. The control device for the bearingless motor according to claim 1, wherein the speed estimating circuitry sets a coordinate center of an axial position of the rotor as a center position magnetically facing the stator, and outputs the estimated axial speed corresponding to a value obtained by time-differentiating an absolute value of the axial position.

4. The control device for the bearingless motor according to claim 2, further comprising a current command value generating circuitry to output a command value of a current in the d axis in response to input of the estimated axial speed.

5. The control device for the bearingless motor according to claim 4, wherein the current command value generating circuitry outputs a command value of a positive current in the d axis when the estimated axial speed is a positive value, and outputs a command value of a negative current in the d axis when the estimated axial speed is a negative value.

6. The control device for the bearingless motor according to claim 1, wherein
the observing circuitry performs estimation assuming that the rotor of the bearingless motor does not move in the axial direction, and
the speed estimating circuitry obtains an axial speed from a relational expression between a current error and an axial speed, the current error being a difference between an estimated current obtained by the observing circuitry and a current of the electric motor winding including influence of the axial speed.

7. The control device for the bearingless motor according to claim 1, wherein the speed estimating circuitry outputs the estimated axial speed in response to input of the current error, and outputs an estimated rotation angular speed that is an estimated value of a rotation angular speed of the rotor in response to input of the current error.

8. A control device for a bearingless motor, the bearingless motor including a rotor and a stator including an electric motor winding that generates torque, the rotor and the stator being disposed with a predetermined gap, the control device being configured to control the bearingless motor, the control device comprising:
observing circuitry to compute an estimated current based on a voltage command value of the electric motor winding or a voltage detection value that is a detection value of a voltage applied to the electric motor winding, the estimated current being an estimated value of a current flowing through the bearingless motor; and
axial position control circuitry to output a d-axis current command value for controlling an axial position of the rotor in response to input of a current error, the current error being a difference between the estimated current and a current detection value that is a value of a current of the electric motor winding.

9. The control device for the bearingless motor according to claim 1, further comprising,
in a case where the voltage command value is used:
current detecting circuitry to detect a current of the electric motor winding; and
current control circuitry to output the voltage command value such that the current detection value detected by the current detecting circuitry matches the current command value.

10. A motor system comprising:
a control device for the bearingless motor according to claim 1; and
a bearingless motor to be controlled by the control device.

11. A control method for a bearingless motor, the bearingless motor including a rotor and a stator including an electric motor winding that generates torque, the rotor and the stator being disposed with a predetermined gap, the control method being for controlling the bearingless motor, the control method comprising:
computing an estimated current based on a voltage command value of the electric motor winding or a voltage detection value that is a detection value of a voltage applied to the electric motor winding, the estimated current being an estimated value of a current flowing through the bearingless motor; and
estimating and outputting an estimated axial speed that is an estimated value of an axial speed of the rotor in response to input of a current error, the current error being a difference between the estimated current and a current detection value that is a value of a current of the electric motor winding.

12. The control device for the bearingless motor according to claim 2, wherein
the observing circuitry performs estimation assuming that the rotor of the bearingless motor does not move in the axial direction, and
the speed estimating circuitry obtains an axial speed from a relational expression between a current error and an axial speed, the current error being a difference between an estimated current obtained by the observing circuitry and a current of the electric motor winding including influence of the axial speed.

13. The control device for the bearingless motor according to claim 8, further comprising,
in a case where the voltage command value is used:
current detecting circuitry to detect a current of the electric motor winding; and
current control circuitry to output the voltage command value such that the current detection value detected by the current detecting circuitry matches the current command value.

14. A motor system comprising:
a control device for the bearingless motor according to claim 8; and
a bearingless motor to be controlled by the control device.
